(19) United States
(12) Patent Application Publication
(10) Pub. No.: US 2026/0197562 A1
(43) Pub. Date: Jul. 9, 2026

(54) PHOTODETECTION ELEMENT AND ELECTRONIC DEVICE

(71) Applicant: SONY SEMICONDUCTOR SOLUTIONS CORPORATION, KANAGAWA (JP)

(72) Inventor: TERUKAZU TANAKA, KANAGAWA (JP)

(21) Appl. No.: 19/133,951

(22) PCT Filed: Nov. 28, 2023
(86) PCT No.: PCT/JP2023/042452

§ 371 Date: May 29, 2025

(30) Foreign Application Priority Data
Dec. 5, 2022 (JP) 2022-194506

(51) Int. Cl. H04N 25/47; H04N 25/571; H04N 25/633; H04N 25/707; H04N 25/79

(52) U.S. Cl. CPC H04N 25/47; H04N 25/573; H04N 25/633; H04N 25/707; H04N 25/79

(57) ABSTRACT

Erroneous event detection caused by crosstalk is to be suppressed in a case where a pixel that detects an event and a pixel that outputs gradation information coexist. A photodetection element, which includes a plurality of pixel groups in which each of the plurality of pixel groups includes a first pixel and a first pixel circuit that output a pixel signal corresponding to a light amount of incident light, a second pixel that detects a change amount of the light amount of the incident light, and a second pixel circuit that compares the change amount detected by the second pixel with a bias signal to detect an event, includes a correction signal generation circuit that generates a correction signal for offsetting crosstalk in which the pixel signal affects the detection of the event, and a bias correction circuit that generates a bias correction signal obtained by correcting the bias signal on the basis of the correction signal, in which the second pixel circuit compares the change amount of the light amount of the incident light with the bias correction signal to detect the event.

### TECHNICAL FIELD

The present disclosure relates to a photodetection element and an electronic device.

### BACKGROUND ART

An event-based vision sensor (EVS) has been proposed that obtains, in an imaging scene, only data of a photoelectric conversion element in which some event such as a luminance change has occurred at high speed. The photodetection element for the EVS includes a plurality of pixels that detects a luminance change of the photoelectric conversion element as an event signal, and a plurality of signal lines that transmits the event signal. In the photodetection element for the EVS, an event may be erroneously detected due to disturbance such as power-supply noise. Patent Document 1 proposes a method of improving accuracy of image processing by providing a circuit for offsetting disturbance.

### CITATION LIST

### Patent Document

Patent Document 1: Japanese Patent Application Laid-Open No. 05-316348 SONY

### SUMMARY OF THE INVENTION

### Problems to be Solved by the Invention

The pixel for the EVS has a configuration for detecting a luminance change of the photoelectric conversion element as an event. The pixel for the EVS may be mixed with a pixel having another configuration (e.g., pixel for imaging). Between the pixel for the EVS and the pixel having the another configuration, crosstalk occurs in which a potential change of a signal line interferes with another adjacent signal line or pixel. In Patent Document 1, only disturbance in a case where pixels have a uniform configuration is corrected, and crosstalk in a case where pixels having different configurations are mixed is not considered.

In view of the above, the present disclosure provides a photodetection element and an electronic device that suppress a problem caused by crosstalk in a case where a pixel that detects an event and a pixel that outputs gradation information are mixed.

### Solutions to Problems

In order to solve the problem described above, according to the present disclosure, there is provided a photodetection element including a plurality of pixel groups,
each of the plurality of pixel groups including:
a first pixel and a first pixel circuit that output a pixel signal corresponding to a light amount of incident light;
a second pixel that detects a change amount of the light amount of the incident light; and
a second pixel circuit that compares the change amount detected by the second pixel with a bias signal to detect an event,
the photodetection element including:
a correction signal generation circuit that generates a correction signal for offsetting crosstalk in which the pixel signal affects the detection of the event; and
a bias correction circuit that generates a bias correction signal obtained by correcting the bias signal on the basis of the correction signal, in which
the second pixel circuit compares the change amount of the light amount of the incident light with the bias correction signal to detect the event.

A dummy pixel group having the same structure as at least a part of the pixel group and light-shielded may be included, and the correction signal generation circuit may generate the correction signal on the basis of an output signal of the dummy pixel group.

The dummy pixel group may have the same circuit configuration, shape, and size as at least a part of the pixel group.

The dummy pixel group may include:
a first dummy pixel and a first dummy pixel circuit having the same structure as at least a part of the first pixel and the first pixel circuit; and
a second dummy pixel and a second dummy pixel circuit having the same structure as at least a part of the second pixel and the second pixel circuit, and
the correction signal generation circuit may generate the correction signal on the basis of an output signal of the second dummy pixel circuit.

The first pixel may include a first photoelectric conversion element that accumulates a charge corresponding to the light amount of the incident light,
the second pixel may include a second photoelectric conversion element that accumulates the charge corresponding to the light amount of the incident light,
the first dummy pixel may include a third photoelectric conversion element that has the same structure as the first photoelectric conversion element and accumulates the charge in a light-shielded state,
the second dummy pixel may include a fourth photoelectric conversion element that has the same structure as the second photoelectric conversion element and accumulates the charge in the light-shielded state,
the first pixel circuit may output the pixel signal on the basis of the charge accumulated in the first photoelectric conversion element,
the second pixel circuit may detect the event on the basis of the charge accumulated in the second photoelectric conversion element,
the first dummy pixel circuit may output a dummy pixel signal on the basis of the charge accumulated in the third photoelectric conversion element, and
the second dummy pixel circuit may detect a dummy event on the basis of the charge accumulated in the fourth photoelectric conversion element.

The first pixel may include a first photoelectric conversion element that accumulates a charge corresponding to the light amount of the incident light,
the second pixel may include a second photoelectric conversion element that accumulates the charge corresponding to the light amount of the incident light,
the first dummy pixel may include a first current source that carries a current equivalent to a current corresponding to the charge accumulated in the first photoelectric conversion element,
the second dummy pixel may include a second current source that carries a current equivalent to the current corresponding to the charge accumulated in the first photoelectric conversion element,
the first pixel circuit may output the pixel signal on the basis of the charge accumulated in the first photoelectric conversion element,
the second pixel circuit may detects the event on the basis of the charge accumulated in the second photoelectric conversion element,
the first dummy pixel circuit may output a dummy pixel signal on the basis of the current flowing through the first current source, and
the second dummy pixel circuit may detect a dummy event on the basis of the current flowing through the second current source.

The plurality of pixel groups may include
two or more of the pixel groups arranged along a first direction; and
two or more of the dummy pixel groups arranged along the first direction,
the correction signal generation circuit may be provided for each of the two or more dummy pixel groups, and
the correction signal generation circuit may generate the correction signal on the basis of the output signal of the dummy pixel group corresponding to the correction signal generation circuit.

The plurality of pixel groups may include two or more of the pixel groups arranged along a second direction that intersects the first direction, and
the output signal of each of the two or more dummy pixel groups arranged along the first direction may be supplied to the correction signal generation circuit of the corresponding pixel group arranged along the second direction.

There may be provided with a first pixel region including the plurality of pixel groups arranged along a first direction and a second direction that intersect each other; and
a second pixel region that is arranged at an end of the first pixel region in the first direction or in the second direction and includes the dummy pixel group.

A plurality of signal lines that is arranged in the first direction in a manner of being spaced apart from each other and extends in the second direction may be included,
each of the plurality of signal lines may transmit the pixel signal output from a plurality of the first pixels arranged along the second direction,
a plurality of the correction signal generation circuits and a plurality of the bias correction circuits may be provided in association with the plurality of signal lines, and
each of the plurality of the correction signal generation circuits may generate the correction signal according to a potential change of the corresponding signal line.

The second pixel region may be arranged at an end of the first pixel region in the second direction.

A plurality of selection control lines that is arranged in the second direction in a manner of being spaced apart from each other and extends in the first direction may be included,
each of the plurality of selection control lines may transmit a selection control signal that selects a plurality of the first pixels arranged along the first direction,
a plurality of the correction signal generation circuits and a plurality of the bias correction circuits may be provided in association with the plurality of selection control lines, and
each of the plurality of correction signal generation circuits may generate the correction signal according to a potential change of the corresponding selection control line.

The second pixel region may be arranged at an end of the second pixel region in the first direction.

There may be provided with a plurality of signal lines that is arranged in the first direction in a manner of being spaced apart from each other and extends in the second direction; and
a plurality of the first pixels and the first pixel circuits respectively connected to the plurality of signal lines,
each of the plurality of first pixel circuits may include an A/D converter that performs analog-digital conversion on the pixel signal corresponding to the light amount of the incident light, and
each of the plurality of signal lines may transmit the pixel signal that has been subject to the analog-digital conversion in the plurality of first pixels arranged along the second direction.

A pixel array unit including the first pixel region and the second pixel region may be included, and
the second pixel region may be arranged in an optical black region arranged at at least one end of the pixel array unit in the first direction or in the second direction.

The second pixel circuit may include a comparator that compares the bias correction signal with a signal corresponding to the change amount of the light amount of the incident light.

The comparator may include a first transistor of a first conductivity type and a second transistor of a second conductivity type cascode-connected between a first reference voltage node and a second reference voltage node,
a voltage signal corresponding to the change amount of the light amount of the incident light may be input to a gate of the first transistor,
the bias correction signal may be input to a gate of the second transistor, and
a detection signal of the event may be output from a connection node of the first transistor and the second transistor.

The comparator may include:
a first transistor of a first conductivity type and a second transistor of a second conductivity type cascode-connected between a first reference voltage node and a second reference voltage node; and
a third transistor of the first conductivity type and a fourth transistor of the second conductivity type cascode-connected between the first reference voltage node and the second reference voltage node,
the bias correction signal may be input to a gate of the third transistor,
a voltage signal corresponding to the change amount of the light amount of the incident light may be input to a gate of the first transistor, a drain and a gate of the second transistor, and a gate of the fourth transistor, and
a detection signal of the event may be output from a connection node of the third transistor and the fourth transistor.

Furthermore, according to the present disclosure, there is provided an electronic device including:
a photodetection element; and
a processing unit that processes image data output from the photodetection element, in which
the photodetection element includes a photodetection element in which:
a plurality of pixel groups is included; and
each of the plurality of pixel groups includes:
a first pixel and a first pixel circuit that output a pixel signal corresponding to a light amount of incident light;
a second pixel that detects a change amount of the light amount of the incident light; and
a second pixel circuit that compares the change amount detected by the second pixel with a bias signal to detect an event,
the photodetection element including:
a correction signal generation circuit that generates a correction signal for offsetting crosstalk in which the pixel signal affects the detection of the event; and
a bias correction circuit that generates a bias correction signal obtained by correcting the bias signal on the basis of the correction signal, in which
the second pixel circuit compares the change amount of the light amount of the incident light with the bias correction signal to detect the event.

### BRIEF DESCRIPTION OF DRAWINGS

FIG. 1 is a block diagram of an electronic device according to a first embodiment of the present disclosure.

FIG. 2 is a diagram illustrating an exemplary stacked structure of a photodetection element.

FIG. 3 is a block diagram of a photodetection element according to the first embodiment of the present disclosure.

FIG. 4 is a circuit diagram illustrating an exemplary configuration of a gradation pixel.

FIG. 5 is a circuit diagram illustrating an exemplary configuration of an EVS pixel and an EVS pixel circuit.

FIG. 6 is a diagram illustrating a first example of crosstalk that may occur between the gradation pixel and the EVS pixel.

FIG. 7 is a diagram schematically illustrating the EVS pixel circuit in which crosstalk occurs in a case where high-intensity light is incident on a gradation pixel of a pixel group at a specific pixel position.

FIG. 8 is a block diagram illustrating a detailed configuration of a pixel array unit and a correction circuit according to the first embodiment of the present disclosure.

FIG. 9 is a block diagram for explaining a crosstalk correction method of the photodetection element according to the first embodiment of the present disclosure.

FIG. 10 is a detailed circuit diagram of a correction signal generation circuit and a bias correction circuit.

FIG. 11 is a timing chart of crosstalk correction according to the first embodiment of the present disclosure.

FIG. 12A is a diagram illustrating a first variation of a comparator.

FIG. 12B is a diagram illustrating a second variation of the comparator.

FIG. 13 is a diagram illustrating a variation of a dummy gradation pixel and a dummy EVS pixel.

FIG. 14 is a circuit diagram illustrating a second example of the crosstalk between the gradation pixel and the EVS pixel.

FIG. 15 is a diagram schematically illustrating the EVS pixel circuit in which the crosstalk occurs in a case where signal logic of a selection control signal transitions in the gradation pixel of the pixel group at the specific pixel position.

FIG. 16 is a block diagram illustrating a detailed configuration of a pixel array unit and a correction circuit according to a second embodiment of the present disclosure.

FIG. 17 is a circuit diagram illustrating a variation of the gradation pixel circuit.

FIG. 18 is a block diagram illustrating an exemplary schematic configuration of a vehicle control system.

FIG. 19 is an explanatory view illustrating exemplary installation positions of an outside-vehicle information detecting section and an imaging section.

### MODE FOR CARRYING OUT THE INVENTION

Hereinafter, embodiments of a photodetection element and an electronic device will be described with reference to the drawings. Although principal components of the photodetection element and the electronic device will be mainly described below, the photodetection element and the electronic device may include components and functions that are not illustrated or described. The following description is not intended to exclude components and functions that are not illustrated or described.

### First Embodiment

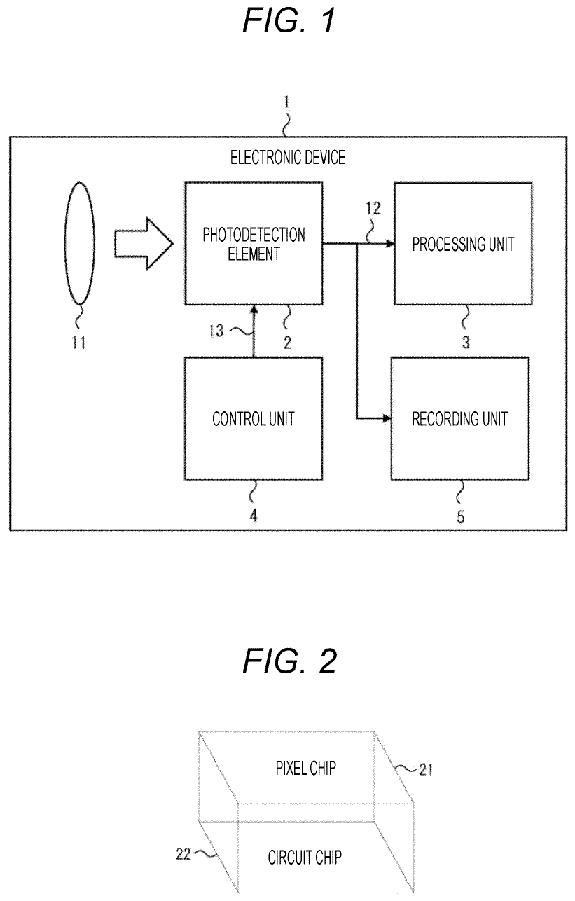

FIG. 1 is a block diagram of an electronic device 1 including a photodetection element 2 according to a first embodiment of the present disclosure. The electronic device 1 captures image data and detects an event, and includes an imaging lens 11, the photodetection element 2, a processing unit 3, and a control unit 4. For example, while a camera mounted on an industrial robot, a vehicle-mounted camera, or the like is assumed as the electronic device 1, the electronic device 1 has any specific application and configuration.

The imaging lens 11 condenses and guides incident light to the photodetection element 2. The photodetection element 2 photoelectrically converts the incident light to capture image data and to detect an event. The photodetection element 2 has functions of, for example, an image sensor and an EVS. More specifically, the photodetection element 2 performs predetermined signal processing, such as image recognition processing, on the basis of captured image data. Furthermore, the photodetection element 2 may generate an event detection image on the basis of an event detection position, detection time, a type of the detected event, and the like. Moreover, the photodetection element 2 may combine an image including gradation information and the event detection image. The image data and the event detection image data output from the photodetection element 2 are input to the processing unit 3 via a transmission line 12. The processing unit 3 performs predetermined image processing or the like on the image data and the event detection image data from the photodetection element 2.

The electronic device 1 may include a recording unit 5. The recording unit 5 records the image data and the event detection image data input from the photodetection element 2 via the transmission line 12. The recording unit 5 may be disposed in a server or the like connected via a network. The control unit 4 controls imaging timing of the photodetection element 2 and the like via a control line 13.

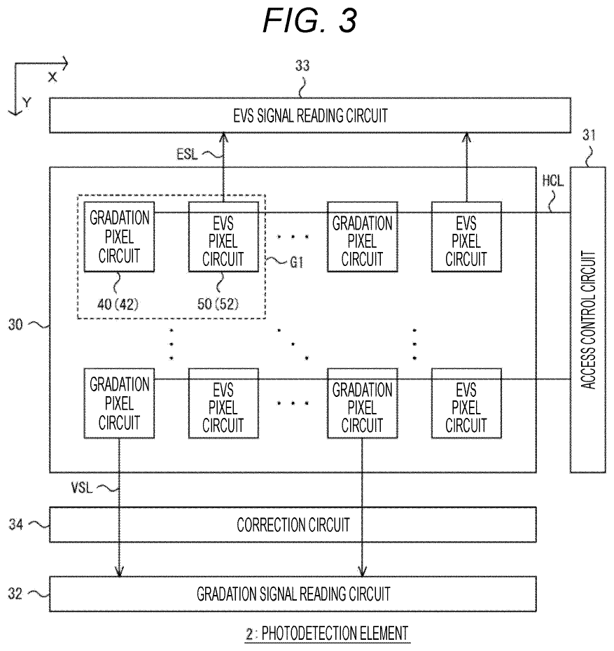

The photodetection element 2 may have a structure in which a plurality of chips is stacked. FIG. 2 is a diagram illustrating an exemplary stacked structure of the photodetection element 2. The photodetection element 2 includes a pixel chip 21 and a circuit chip 22 stacked on the pixel chip 21. Those chips are joined by a via or the like. Note that the respective chips 21 and 22 may be joined by Cu—Cu bonding or a bump in addition to the via.

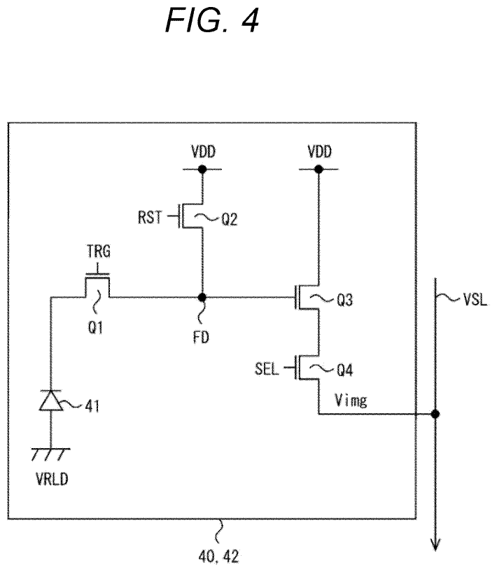

FIG. 3 is a block diagram of the photodetection element 2 according to the first embodiment of the present disclosure. In the photodetection element 2, multiple pixels having different configurations are combined. The photodetection element 2 includes a pixel array unit 30, an access control circuit 31, a gradation signal reading circuit 32, an EVS signal reading circuit 33, and a correction circuit 34.

The pixel array unit 30 includes a plurality of pixel groups G1 arranged in a first direction X and a second direction Y. Each of the pixel groups G1 includes a gradation pixel (first pixel) 40, a gradation pixel circuit (first pixel circuit) 42, an EVS pixel (second pixel) 50, and an EVS pixel circuit (second pixel circuit) 52. The gradation pixel 40 and the gradation pixel circuit 42 may be integrally arranged, or may be arranged on separate substrates (chips). Likewise, the EVS pixel 50 and the EVS pixel circuit 52 may be integrally arranged, or may be arranged on separate substrates (chips). The blocks named “gradation pixel circuit” and “EVS pixel circuit” illustrated in FIG. 1 and the like are intended to include the “gradation pixel” and “EVS pixel”. The gradation pixel 40 detects a light amount of the incident light. The EVS pixel 50 detects a change amount of the light amount of the incident light. In the present specification, the left-right (horizontal) direction in FIG. 3 is referred to as the first direction X, and the top-down (vertical) direction in FIG. 3 is referred to as the second direction Y.

While FIG. 3 illustrates an exemplary case where the gradation pixel 40 and the EVS pixel 50 in each of the pixel groups G1 are arranged adjacent to each other in the first direction X, it is not limited thereto. The gradation pixel 40 and the EVS pixel 50 in each of the pixel groups G1 may be arranged adjacent to each other in the second direction X, or a plurality of the gradation pixels 40 may be arranged to surround the EVS pixel 50 in each of the pixel groups G1. Furthermore, in the present specification, one row of the gradation pixels 40 and the EVS pixels 50 arranged in the first direction X is referred to as a pixel row. One column of the gradation pixels 40 or the EVS pixels 50 arranged in the second direction Y is referred to as a pixel column.

In the pixel array unit 30, in addition to the gradation pixels 40 and the EVS pixels 50, dummy pixels (not illustrated) and the like are arranged. A detailed configuration of the pixel array unit 30 will be described later.

The gradation pixel circuit 42 outputs pixel signals corresponding to the light amount of the incident light detected by the gradation pixel 40. The pixel signal includes luminance and color information of a subject. The gradation pixel circuit 42 may include a signal processing circuit, such as an analog-to-digital converter (ADC) that performs analog-digital conversion on the pixel signal.

The EVS pixel circuit 52 compares the change amount of the light amount of the incident light detected by the EVS pixel 50 with a predetermined threshold to detect an event. An event signal indicating a detection result of the event includes event detection information indicating whether or not a change in the luminance of the subject exceeds a predetermined threshold.

The access control circuit 31 sequentially selects pixel rows, and drives the gradation pixel circuit 42 for each pixel row. A selection control line HCL is connected to the access control circuit 31 for each pixel row. The individual selection control lines HCL are connected to all the gradation pixel circuits 42 of the corresponding pixel row. The EVS pixel circuit 52 outputs an event signal when an event is detected in a case of an asynchronous type, and outputs an event signal in accordance with an instruction from the access control circuit 31 in a case of a synchronous type.

The gradation signal reading circuit 32 reads a pixel signal from the gradation pixel circuit 42 (gradation pixel 40), and outputs it to a signal processing unit or the like at a subsequent stage. A signal line VSL is connected to the gradation signal reading circuit 32 for each pixel column. Each signal line VSL transmits the pixel signals output from all the gradation pixel circuits 42 (gradation pixels 40) of the corresponding pixel column.

The EVS signal reading circuit 33 reads an event signal from the EVS pixel circuit 52, and outputs it to a signal processing unit (not illustrated) or the like. An event signal line ESL is connected to the EVS signal reading circuit 33 for each pixel column. Each event signal line ESL transmits the event signals output from all the EVS pixel circuits 52 of the corresponding pixel column.

The correction circuit 34 supplies a bias correction signal for correcting a bias signal used in the EVS pixel circuit 52.

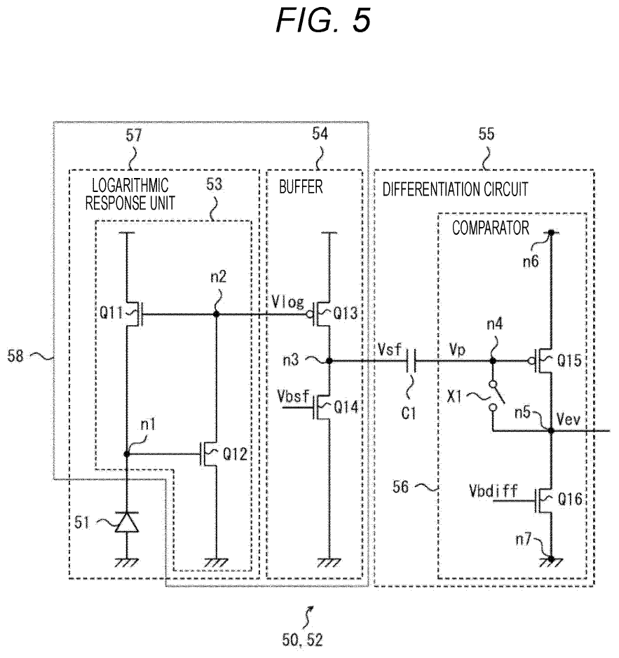

FIG. 4 is a circuit diagram illustrating an exemplary configuration of the gradation pixel 40 and the gradation pixel circuit 42. The gradation pixel 40 and the gradation pixel circuit 42 in FIG. 4 include a photoelectric conversion element (first photoelectric conversion element) 41, a transfer transistor Q1, a reset transistor Q2, an amplification transistor Q3, and a selection transistor Q4. More specifically, in the circuit of FIG. 4, a part of the component including the photoelectric conversion element 41 is the gradation pixel 40, and the rest is the gradation pixel circuit 42, but the gradation pixel 40 and the gradation pixel circuit 42 may be separated in any manner.

The photoelectric conversion element 41 accumulates charges (which will be referred to as photocharges hereinafter) corresponding to the light amount of the incident light with respect to the corresponding gradation pixel 40. As the photoelectric conversion element 41, for example, a photodiode is used. The gradation pixel circuit 42 outputs pixel signals corresponding to the light amount of the incident light on the basis of the photocharges accumulated in the photoelectric conversion element 41. The pixel signals output from the gradation pixel circuit 42 are input to the gradation signal reading circuit 32 via the signal line VSL.

The gradation pixel circuit 42 includes the transfer transistor Q1, the reset transistor Q2, and the amplification transistor Q3. The transfer transistor Q1, the reset transistor Q2, and the amplification transistor Q3 are connected to a floating diffusion (floating diffusion region) FD. Note that at least one of the transfer transistor Q1, the reset transistor Q2, or the amplification transistor Q3 may be provided in the gradation pixel 40.

In the present specification, an example will be described in which four transistors of the transfer transistor Q1, the reset transistor Q2, the amplification transistor Q3, and the selection transistor Q4 are configured by, for example, N-channel metal-oxide-semiconductor (NMOS) transistors. Note that any conductivity type may be used for the four transistors exemplified here. Any of the four transistors may be configured by, for example, a P-channel metal-oxide-semiconductor (PMOS) transistor.

Note that, in the present specification, one (e.g., PMOS transistor) of the NMOS transistor and the PMOS transistor is referred to as a transistor of a first conductivity type, and the other (e.g., NMOS transistor) is referred to as a transistor of a second conductivity type.

FIG. 4 illustrates an example of a 4-Tr configuration in which the gradation pixel 40 and the gradation pixel circuit 42 include four transistors (Tr). The number of transistors included in the pixel circuit is not limited to four. For example, a 3-Tr configuration may be employed in which the selection transistor Q4 is omitted and the amplification transistor Q3 has a function of the selection transistor Q4, or a configuration of 5-Tr or more may be employed in which the number of transistors is increased as necessary.

The photoelectric conversion element 41 includes an anode and a cathode. In the photoelectric conversion element 41, one of the cathode or the anode (e.g., cathode) is connected to the transfer transistor Q1, and the other (e.g., anode) is connected to a reference voltage node VRLD such as ground.

The transfer transistor Q1 is used to switch transfer of the photocharges. In the transfer transistor Q1, the source and the drain are connected to the photoelectric conversion element 41 and the floating diffusion FD, respectively. The transfer transistor Q1 is turned on by application of a transfer signal TRG at a high level (e.g., at a level of high-potential side power supply VDD to be described later) to the gate. With this arrangement, the photocharges accumulated in the photoelectric conversion element 41 are transferred to the floating diffusion FD.

The reset transistor Q2 is used to reset an amount of photocharges in the gradation pixel 40. In the reset transistor Q2, the source and the drain are connected to the floating diffusion FD and a node of the high-potential side power supply voltage VDD, respectively. The reset transistor Q2 is turned on by application of a reset signal RST at a high level to the gate. With this arrangement, the charges of the floating diffusion FD are discharged to the node of the high-potential side power supply voltage VDD, whereby the floating diffusion FD is reset.

The floating diffusion FD accumulates the photocharges transferred from the photoelectric conversion element 41. With this arrangement, the floating diffusion FD has a potential corresponding to the accumulated charges.

The gate of the amplification transistor Q3 has the same potential as the floating diffusion FD, and is used as an input part of a source follower circuit. The drain and the source of the amplification transistor Q3 are connected to the node of the high-potential side power supply voltage VDD and the selection transistor Q4, respectively. A source voltage of the amplification transistor Q3 changes depending on the potential of the floating diffusion FD. The source of the amplification transistor Q3 is connected to the drain of the selection transistor Q4.

The selection control line HCL is connected to the gate of the selection transistor Q4, and a selection control signal SEL is applied from the access control circuit 31. With this arrangement, a plurality of pixel rows each extending in the first direction X and arranged in the second direction Y is driven by the corresponding selection control signal SEL for each pixel row. The selection transistor Q4 is turned on when the selection control signal SEL is at a high level, and a pixel signal Vimg of a voltage level corresponding to the potential of the floating diffusion FD is transmitted from the source of the selection transistor Q4 to the signal line VSL.

For example, in a case where a light amount of light incident on the photoelectric conversion element 41 is large, the voltage on the cathode side of the photoelectric conversion element 41 decreases. As a result, when the potential of the floating diffusion FD decreases and the selection transistor Q4 is turned on, the potential of the pixel signal Vimg output to the signal line VSL decreases.

The photoelectric conversion element 41 and the gradation pixel circuit 42 illustrated in FIG. 4 are arranged on, for example, the pixel chip 21 in FIG. 2. Note that a part or all of the gradation pixel circuit 42 may be arranged on the circuit chip 22.

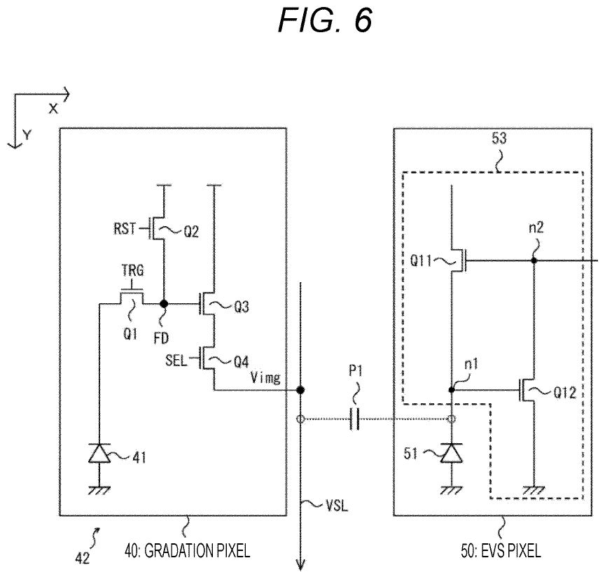

FIG. 5 is a circuit diagram illustrating an exemplary configuration of the EVS pixel 50 and the EVS pixel circuit 52. The EVS pixel 50 includes a photoelectric conversion element (second photoelectric conversion element) 51 and a current-voltage conversion circuit 53.

The EVS pixel 50 and the EVS pixel circuit 52 detect an event by comparing the change amount of the light amount of the incident light with a bias signal Vbdiff to be described later, and output an event signal. While an exemplary case where the EVS pixel 50 includes a preceding stage side of a buffer 54 and the EVS pixel circuit 52 includes the buffer 54 and a differentiation circuit 55 will be described in the present specification, the EVS pixel 50 and the EVS pixel circuit 52 may be separated in any manner. While the EVS pixel circuit 52 may include a logic circuit, such as a latch circuit that outputs a final event signal, illustration is omitted in FIG. 5.

The current-voltage conversion circuit 53 and the photoelectric conversion element 51 are included in a logarithmic response unit 57. The logarithmic response unit 57 performs logarithmic conversion on the charges photoelectrically converted by the photoelectric conversion element 51 to generate a voltage signal Vlog. A reason for the logarithmic conversion is to widen a dynamic range of the EVS pixel 50 for obtaining luminance information.

The photoelectric conversion element 51 accumulates charges (photocharges) based on the incident light incident on the corresponding EVS pixel 50. One of the anode or the cathode (cathode in the example of FIG. 5) of the photoelectric conversion element 51 is connected to an input node n1 of the current-voltage conversion circuit 53, and the other (anode in the example of FIG. 5) is connected to a predetermined reference voltage node such as a ground voltage.

The current-voltage conversion circuit 53 converts the charges accumulated in the photoelectric conversion element 51 into a voltage. The current-voltage conversion circuit 53 includes transistors Q11 and Q12. As the transistors Q11 and Q12, for example, NMOS transistors are used.

The source of the transistor Q11 is connected to the cathode of the photoelectric conversion element 51 and the gate of the transistor Q12. The gate of the transistor Q11 is connected to the drain of the transistor Q12 and an output node n2 of the current-voltage conversion circuit 53. The source of the transistor Q12 is connected to the reference voltage (ground) node.

The voltage signal Vlog obtained by the logarithmic conversion performed by the current-voltage conversion circuit 53 is input to the buffer 54. The buffer 54 includes transistors Q13 and Q14 cascode-connected between the power supply voltage node and the reference (ground) voltage node. As the transistor Q13, for example, a PMOS transistor is used. As the transistor Q14, for example, an NMOS transistor is used.

The transistor Q13 in the buffer 54 is included in the source follower circuit. The voltage signal Vlog is input to the gate of the transistor Q13 from the output node n2 of the current-voltage conversion circuit 53. The source of the transistor Q13 is connected to the power supply voltage node, and the drain is connected to the differentiation circuit 55 via an output node n3 of the buffer 54.

The source of the transistor Q14 is connected to the reference (ground) voltage node, and the drain is connected to the drain of the transistor Q13. A bias voltage Vbsf is applied to the gate of the transistor Q14. The transistor Q14 adjusts a voltage level of the drain of the transistor Q13 according to a voltage level of the bias voltage Vbsf. A pixel voltage Vsf corresponding to the voltage signal Vlog output from the current-voltage conversion circuit 53 is output from the buffer 54.

The pixel voltage Vsf output from the buffer 54 is input to the differentiation circuit 55. The buffer 54 may improve the driving force of the pixel voltage Vsf. Furthermore, with the buffer 54 provided, isolation may be secured in which noise generated when a comparator 56 at a subsequent stage performs a switching operation is not to be transmitted to the current-voltage conversion circuit 53.

Note that, in the present specification, the buffer 54 and the current-voltage conversion circuit 53 are collectively referred to as an event detection unit 58.

The differentiation circuit 55 detects a temporal change amount of the pixel voltage Vsf output from the buffer 54. The differentiation circuit 55 includes a capacitor C1 and the comparator 56. The capacitor C1 is disposed between the output node n3 of the buffer 54 and an input node n4 of the comparator 56. The capacitor C1 accumulates charges on the basis of the pixel voltage Vsf output from the buffer 54. The capacitor C1 supplies a voltage Vp corresponding to the change amount of the pixel voltage Vsf to the comparator 56.

When the light amount of the light incident on the EVS pixel 50 increases, photocharges are generated by the photoelectric conversion element 51, and the voltage at the input node n1 connected to the cathode of the photoelectric conversion element 51 decreases. As the voltage at the input node n1 decreases, the output voltage Vlog of the current-voltage conversion circuit 53 decreases, and the output voltage Vsf of the buffer 43 also decreases. The voltage Vp on the side of the comparator 56 of the capacitor C1 decreases as the decrease amount of the output voltage Vsf per unit time increases. A decrease in the voltage Vp indicates an increase in the light amount of the light incident on the EVS pixel 50.

The comparator 56 in the differentiation circuit 55 generates an event signal Vev on the basis of the voltage Vp and the bias signal Vbdiff. The comparator 56 includes a switch X1, a transistor (first transistor) Q15, and a transistor (second transistor) Q16. A PMOS transistor is used as the transistor Q15, and an NMOS transistor is used as the transistor Q16.

The switch X1 switches whether or not to initialize the voltage Vp. For example, the switch X1 short-circuits the gate and the drain of the transistor Q16 each time the comparator 56 to be described later detects an event. With this arrangement, the charges of the capacitor C1 are initialized, and the voltage Vp is set to an initial value.

The transistors Q15 and Q16 are cascode-connected between a power supply voltage node (first reference voltage node) n6 and a reference voltage (e.g., ground) node (second reference voltage node) n7. The source of the transistor Q15 is connected to the power supply voltage node n6, and the drain of the transistor Q15 is connected to the output node n5 of the comparator 56. The source of the transistor Q16 is connected to the reference voltage (e.g., ground) node n7, and the drain of the transistor Q16 is connected to the output node n5 of the comparator 56.

The voltage Vp on one end side of the capacitor C1 is input to the gate of the transistor Q15 via the input node n4. In the present specification, the voltage Vp may be referred to as a differential signal. The bias signal Vbdiff is input from the correction circuit 34 to the gate of the transistor Q16.

The transistors Q15 and Q16 function as an inverting circuit having the connection node n4 on the gate side of the transistor Q15 as an input node and the connection node n5 of the transistors Q15 and Q16 as an output node.

The transistors Q15 and Q16 compare the differential signal Vp with the bias signal Vbdiff. Specifically, the transistor Q15 is turned on when the differential signal Vp of the differentiation circuit 44 is lower than the bias signal Vbdiff, and the event signal Vev output from the drain of the transistor Q16 is at a high level. As described above, the comparator 56 detects an event indicating that the absolute value of the change amount of the light amount of the incident light exceeds a predetermined threshold on the basis of the result of the comparison operation between the differential signal Vp and the bias signal Vbdiff, and outputs the event signal Vev.

The EVS pixel circuit 52 may detect, for example, an increase in the light amount of the incident light of the EVS pixel 50 as an event. As described above, a decrease in the differential signal Vp indicates an increase in the light amount of the light incident on the EVS pixel 50. That is, an output of the high-level event signal Vev indicates that the increase amount of the light amount of the incident light exceeds a threshold determined by the bias signal Vbdiff. In the present specification, the output of the high-level event signal Vev is referred to as event detection.

Alternatively, the EVS pixel circuit 52 may detect a decrease in the light amount of the incident light of the EVS pixel 50 as an event. An increase in the differential signal Vp indicates a decrease in the light amount of the light incident on the EVS pixel 50. The transistor Q15 is turned off when the differential signal Vp of the differentiation circuit 44 is higher than the bias signal Vbdiff, and the event signal Vev is at a low level. The output of the low-level event signal Vev may be referred to as event detection. In this case, the bias signal Vbdiff is used to determine a threshold of a decrease amount of the light amount of the incident light.

Furthermore, another pair of transistors may be added to the comparator 56 separately from the transistor pair including the transistor Q15 and the transistor Q16. Whether or not the increase amount of the light amount of the incident light exceeds a first threshold may be detected in one transistor pair, and whether or not the decrease amount of the light amount of the incident light falls below a second threshold may be detected in another transistor pair. The differential signal Vp allows the EVS pixel circuit 52 to detect an increase and a decrease in the light amount of the incident light of the EVS pixel 50 as respective separate events.

The photoelectric conversion element 51 illustrated in FIG. 5 is arranged on, for example, the pixel chip 21 in FIG. 2. The EVS pixel circuit 52 is arranged on the pixel chip 21 and the circuit chip 22 in a divided manner. For example, the event detection unit 58 is arranged on the pixel chip 21, and the differentiation circuit 55 is arranged on the circuit chip 22. In the present specification, the components arranged on the pixel chip 21 are referred to as the gradation pixel 40 and an EVS pixel 50, and the components arranged on the circuit chip 22 are referred to as the gradation pixel circuit 42 and the EVS pixel circuit 52. As described above, the components arranged on the pixel chip 21 and the circuit chip 22 are optional, and it is also conceivable to adopt a configuration in which all the components are arranged on the same chip or a configuration in which the components are arranged separately on three or more chips.

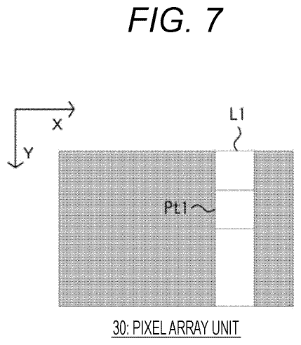

There is a possibility that crosstalk occurs in the EVS pixel 50 due to a potential change of the signal line VSL that transmits the pixel signal of the gradation pixel 40. FIG. 6 is a diagram illustrating a first example of the crosstalk that may occur between the gradation pixel 40 and the EVS pixel 50. As described above, the signal line VSL extends from the gradation pixel 40 along the second direction Y. As illustrated in FIG. 3, in the pixel array unit 30, a plurality of the EVS pixels 50 is arranged adjacent to the signal line VSL.

A parasitic capacitance P1 is formed between the signal line VSL and a signal path connected to the cathode of the photoelectric conversion element 51 in the EVS pixel 50. A capacitance value of the parasitic capacitance P1 increases as the number of pixels increases and a distance between the signal line VSL and the signal path connected to the cathode of the photoelectric conversion element 51 decreases. Furthermore, as a potential change of the pixel signal output from the gradation pixel 40 to the signal line VSL increases, a potential change of the cathode of the photoelectric conversion element 51 in the EVS pixel 50 increases. As described above, in the example of FIG. 6, a potential change of the signal line VSL causes a potential change of the cathode of the photoelectric conversion element 51 via the parasitic capacitance P1, thereby generating crosstalk.

For example, when high-intensity light is incident on the gradation pixel 40, the potential of the pixel signal output from the gradation pixel 40 to the signal line VSL rapidly decreases. Due to this influence, the cathode voltage of the photoelectric conversion element 51 of the adjacent EVS pixel 50 rapidly decreases via the parasitic capacitance P1, and the EVS pixel circuit 52 may erroneously detect an event.

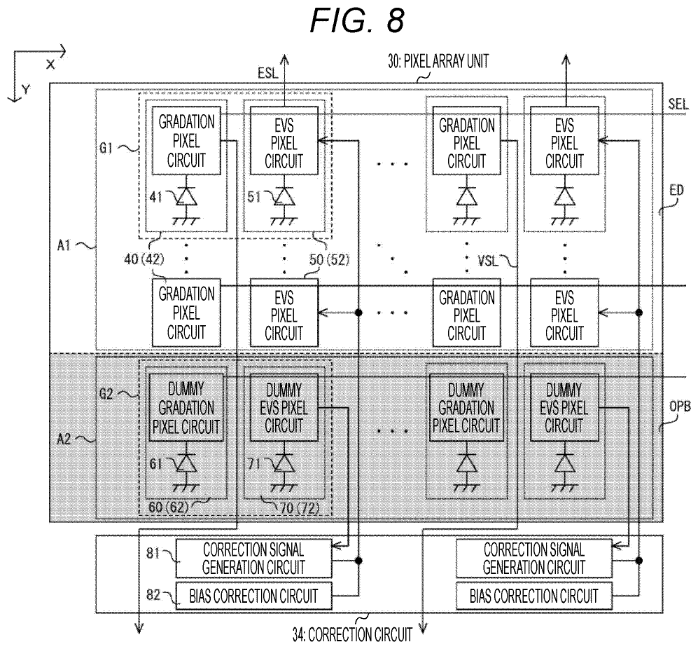

Since the signal line VSL extends in the second direction Y, erroneous detection of an event caused by the crosstalk may simultaneously occur in the plurality of EVS pixel circuits 52 arranged in the second direction Y. FIG. 7 is a diagram schematically illustrating the EVS pixel circuit 52 in which crosstalk occurs in a case where high-intensity light is incident on the gradation pixel 40 of a pixel group Pt1 at a specific pixel position. FIG. 7 illustrates an exemplary case where all the EVS pixel circuits 52 in the same pixel column as the pixel group Pt1 erroneously detect an event. Accordingly, a streaky line L1 appears in the event detection image along the second direction Y.

A photodetection element 2 according to each embodiment to be described below is capable of solving this problem.

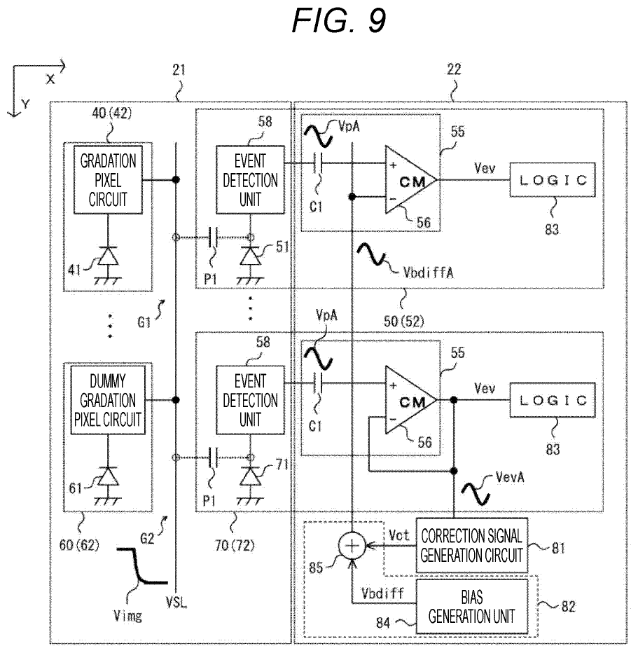

FIG. 8 is a block diagram illustrating a detailed configuration of the pixel array unit 30 and the correction circuit 34 according to the first embodiment of the present disclosure. As illustrated in FIG. 3, the pixel array unit 30 includes the plurality of pixel groups G1 arranged in the first direction X and the second direction Y, and each of the pixel groups G1 includes the gradation pixel 40, the gradation pixel circuit 42, the EVS pixel 50, and the EVS pixel circuit 52. In FIG. 8, the blocks of the gradation pixel 40 and the EVS pixel 50 are omitted for simplification.

As illustrated in FIG. 8, the pixel array unit 30 includes an effective pixel region ED and an optical black region OPB. The effective pixel region ED is a region on which light is incident. The optical black region OPB is a region light-shielded by a metal film or the like. The plurality of pixel groups G1 having the same structure is arranged in the effective pixel region ED and the optical black region OPB. The optical black region OPB is arranged at at least one end (end in the second direction Y in FIG. 8) of the pixel array unit 30 in the first direction X or in the second direction Y. The gradation pixel 40 and the EVS pixel 50 arranged in the optical black region OPB is used to detect a current (dark current) in a state where no light is incident.

In the present embodiment, the plurality of pixel groups G1 arranged in the optical black region OPB are used as a plurality of dummy pixel groups G2 for the crosstalk correction described above. The dummy pixel group G2 has the same structure as the pixel group G1. As will be described later, since the configuration of the dummy pixel group G2 may be partially different from that of the pixel group G1, more precisely, the dummy pixel group G2 has the same structure as at least a part of the pixel group G1. The same structure means having the same circuit configuration, shape, and size and being formed through the same manufacturing process.

Each of the plurality of dummy pixel groups G2 includes a dummy gradation pixel (first dummy pixel) 60, a dummy gradation pixel circuit (first dummy pixel circuit) 62, a dummy EVS pixel (second dummy pixel) 70, and a dummy EVS pixel circuit (second dummy pixel circuit) 72. The dummy gradation pixel 60 and the dummy gradation pixel circuit 62 have the same structure as at least a part of the gradation pixel 40 and the gradation pixel circuit 42. The dummy EVS pixel 70 and the dummy EVS pixel circuit 72 have the same structure as at least a part of the EVS pixel 50 and the EVS pixel circuit 52.

The dummy gradation pixel 60 has the same structure as the gradation pixel 40 including the photoelectric conversion element 41, and includes a photoelectric conversion element (third photoelectric conversion element) 61 that accumulates charges in a light-shielded state. The dummy gradation pixel circuit 62 outputs a dummy pixel signal on the basis of the charges accumulated in the photoelectric conversion element 61. The dummy EVS pixel 70 has the same structure as the EVS pixel 50 including the photoelectric conversion element 51, and includes a photoelectric conversion element (fourth photoelectric conversion element) 71 that accumulates charges in a light-shielded state. The dummy EVS pixel circuit 72 outputs a dummy event on the basis of the charges accumulated in the photoelectric conversion element 71.

The pixel array unit 30 includes a first pixel region A1 and a second pixel region A2. The first pixel region A1 is the effective pixel region ED having the plurality of pixel groups G1 arranged along the first direction X and the second direction Y. The second pixel region A2 includes the plurality of dummy pixel groups G2, which is arranged at an end (in optical black region OPB) of the first pixel region A1 in the second direction Y and is arranged along the first direction X.

The correction circuit 34 includes a plurality of correction signal generation circuits 81 and a plurality of bias correction circuits 82. The correction signal generation circuit 81 generates a correction signal for offsetting crosstalk in which the pixel signal Vimg output from the gradation pixel circuit 42 affects event detection in the EVS pixel circuit 52. The bias correction circuit 82 generates a bias correction signal obtained by correcting the bias signal Vbdiff in FIG. 5 on the basis of the correction signal. The bias correction signal is input to the EVS pixel circuit 52 according to the first embodiment instead of the bias signal Vbdiff. The EVS pixel circuit 52 compares a change amount of the light amount of the incident light with the bias correction signal to detect an event.

The correction signal generation circuit 81 generates a correction signal on the basis of an output signal of the dummy pixel group G2.

The plurality of pixel groups G1 is arranged in the first pixel region A1 along the first direction X, and the plurality of dummy pixel groups G2 is arranged in the second pixel region A2 along the first direction X. Furthermore, in the pixel array unit 30, a plurality of the signal lines VSL extending in the second direction Y is arranged while being spaced apart from each other in the first direction X.

In the first pixel region A1, the plurality of pixel groups G1 is arranged along the second direction Y, and each of the plurality of signal lines VSL transmits the pixel signal Vimg output from the plurality of gradation pixel circuits 42 arranged along the second direction Y. Each of the plurality of dummy EVS pixel circuits 72 arranged in the dummy pixel group G2 is affected by the crosstalk due to the pixel signal Vimg transmitted by the corresponding signal line VSL.

The plurality of correction signal generation circuits 81 and the plurality of bias correction circuits 82 are provided in association with the plurality of signal lines VSL. That is, the correction signal generation circuit 81 and the bias correction circuit 82 are provided for each of the two or more dummy pixel groups G2 arranged along the first direction X.

The output signal of each of the two or more dummy pixel groups G2 arranged along the first direction X is supplied to the corresponding correction signal generation circuit 81. The correction signal generation circuit 81 generates a correction signal on the basis of the output signal of the corresponding dummy pixel group G2. More specifically, the event signal Vev of the dummy EVS pixel circuit 72 is supplied to the corresponding correction signal generation circuit 81 arranged along the second direction Y. The correction signal generation circuit 81 generates a correction signal on the basis of the event signal Vev of the dummy EVS pixel circuit 72. As described above, the event signal Vev of the dummy EVS pixel circuit 72 is a signal affected by the crosstalk. Therefore, each of the plurality of correction signal generation circuits 81 generates a correction signal for offsetting the crosstalk caused by the potential change of the corresponding signal line VSL.

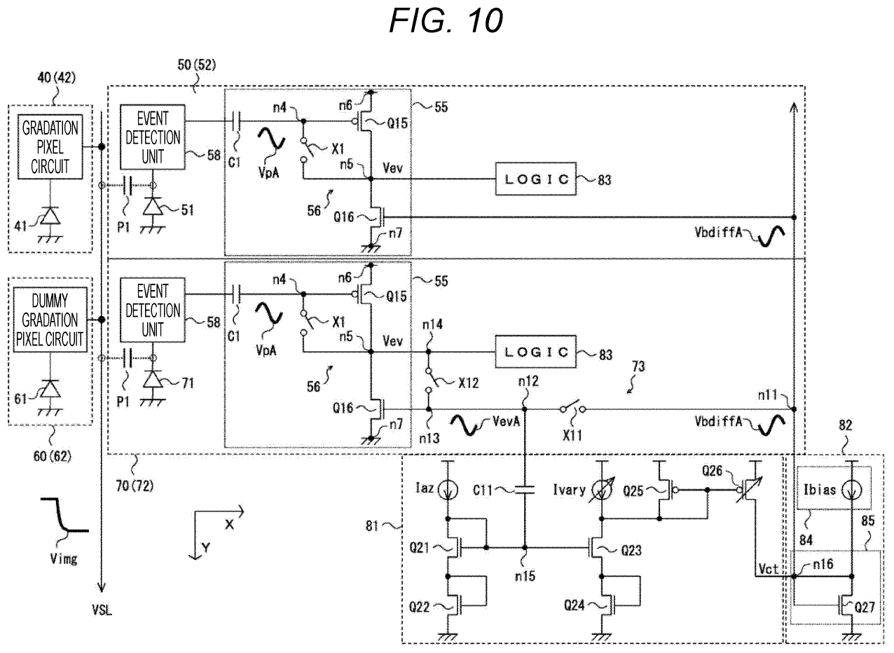

FIG. 9 is a block diagram for explaining a crosstalk correction method of the photodetection element 2 according to the first embodiment of the present disclosure. As described above, the plurality of pixel groups G1 is arranged along the signal line VSL. The dummy pixel group G2 is arranged at an end of the pixel column arranged along the signal line VSL.

Each of the EVS pixel circuit 52 in the pixel group G1 and the dummy EVS pixel circuit 72 in the dummy pixel group G2 includes the event detection unit 58, the differentiation circuit 55, and a logic circuit (LOGIC) 83. In addition, each of the EVS pixel circuit 52 and the dummy EVS pixel circuit 72 outputs the event signal Vev to the logic circuit 83 at the subsequent stage via the comparator 56.

The dummy EVS pixel circuit 72 in the dummy pixel group G2 outputs the event signal Vev to the logic circuit 83, and also outputs the event signal Vev to the correction signal generation circuit 81. A crosstalk correction signal generates a correction signal Vct on the basis of the event signal Vev, and outputs the correction signal Vct to the bias correction circuit 82.

The bias correction circuit 82 includes a bias generation unit 84 and a corrector 85. The bias generation unit 84 generates the bias signal Vbdiff. The bias signal Vdiff is a threshold to be compared with the differential signal Vp by the comparator 56 in the EVS pixel circuit 52 illustrated in FIG. 5. The corrector 85 corrects the bias signal Vbdiff on the basis of the correction signal Vct.

Hereinafter, a method of offsetting the crosstalk by the dummy EVS pixel circuit 72, the correction signal generation circuit 81, and the bias correction circuit 82 will be described with reference to FIG. 9. When high-intensity light is incident on the gradation pixel 40 as in the position P3 in FIG. 7B, the potential of the prime signal Vimg output to the signal line VSL rapidly decreases. As a result, the cathode potential of the photoelectric conversion element 51 of the EVS pixel 50 rapidly decreases via the parasitic capacitance P1, and the event detection unit 58 in the EVS pixel circuit 52 outputs a dummy differential signal VpA. The EVS pixel circuit 52 erroneously detects an event due to the dummy differential signal VpA, and the comparator 56 in the EVS pixel circuit 52 outputs a dummy event signal VevA.

Similar crosstalk occurs also in the dummy pixel group G2 arranged along the signal line VSL in which the potential is rapidly decreased. That is, also in the dummy EVS pixel circuit 72 in the dummy pixel group G2, the event detection unit 58 outputs the dummy differential signal VpA, and the comparator 56 outputs the dummy event signal VevA at a voltage level similar to that of the EVS pixel circuit 52. The dummy event signal VevA output from the dummy EVS pixel circuit 72 is supplied to the correction signal generation circuit 81.

The correction signal generation circuit 81 generates the correction signal Vct on the basis of the dummy event signal VevA output from the dummy EVS pixel circuit 72. The bias correction circuit 82 generates a bias correction signal VbdiffA obtained by correcting the bias signal Vbdiff on the basis of the correction signal Vct. The bias correction signal VbdiffA has noise in phase with or out of phase with the dummy differential signal VpA (in phase in FIG. 9).

The bias correction signal VbdiffA is input to the EVS pixel circuit 52 in the pixel group G1. The comparator 56 in the EVS pixel circuit 52 compares the differential signal Vp with the bias correction signal VbdiffA. As a result, noise is canceled in the comparator 56 in the EVS pixel circuit 52, and the event signal Vev corrects the influence of crosstalk.

As illustrated in FIG. 8, in the first embodiment, the dummy EVS pixel circuit 72, the correction signal generation circuit 81, and the bias correction circuit 82 are provided for each signal line VSL. Therefore, the correction of the crosstalk described above is also carried out for each signal line VSL.

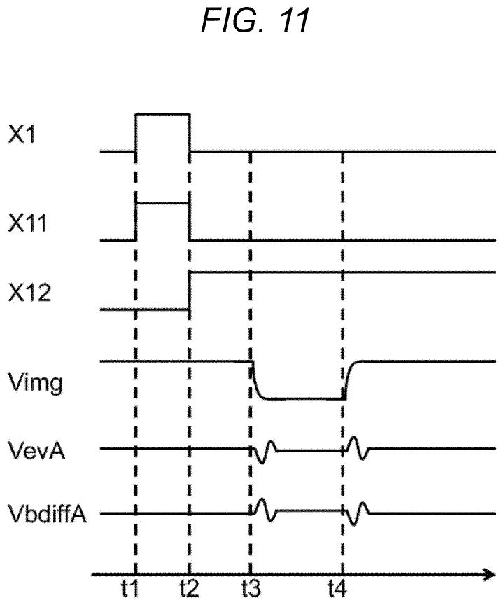

FIG. 10 is a detailed circuit diagram of the correction signal generation circuit 81 and the bias correction circuit 82. The comparator 56 in the dummy EVS pixel circuit 72 is connected to the correction signal generation circuit 81, the bias correction circuit 82, and the logic circuit 83 via a connection unit 73 (not illustrated in FIG. 9). The connection unit 73 includes a switch X11 and a switch X12.

The connection unit 73 is connected to the bias correction circuit 82 via a node n11, connected to the correction signal generation circuit 81 via a node n12, and connected to the comparator 56 in the dummy EVS pixel circuit 72 via a node n13 and a node n14.

The switch X11 switches whether or not to input the bias correction signal VbdiffA output from the bias correction circuit 82 to the comparator 56 in the dummy EVS pixel circuit 72. The switch X11 is disposed between the node n11 and the node n12. The bias correction signal VbdiffA is input from the bias correction circuit 82 to the node n11. When the switch X11 is on, the bias correction signal VbdiffA is input to the gate of the transistor Q16 in the comparator 56 via the node n13.

The switch X12 switches whether or not to input the dummy event signal VevA output from the comparator 56 in the dummy EVS pixel circuit 72 to the correction signal generation circuit 81. The switch X12 is disposed between the node n13 and the node n14. The event signal VevA is input to the node n14 from the output node n5 of the comparator 56. When the switch X12 is on, the dummy event signal VevA is input to the correction signal generation circuit 81 via the node n12.

The correction signal generation circuit 81 includes transistors Q21, Q22, Q23, Q24, Q25, and Q26, current sources Iaz and Ivary, and a capacitor C11. As the transistors Q21, Q22, Q23, and Q24, for example, NMOS transistors are used. As the transistors Q25 and Q26, for example, PMOS transistors are used.

The capacitor C11 is disposed between the node n12 and the node n15. The dummy event signal VevA is input from the connection unit 73 to one end (node n12 side) of the capacitor C11. The potential of another end (node n15 side) of the capacitor C11 changes depending on the potential of the dummy event signal VevA.

The transistors Q21 and Q22 are cascode-connected between the current source Iaz and the reference (ground) voltage node. The drain of the transistor Q21 is connected to the current source Iaz, and is short-circuited to the gate of the transistor Q21. The gate of the transistor Q21 is connected to the node n15. The source of the transistor Q21 is connected to the gate and the drain of the transistor Q22. The source of the transistor Q22 is connected to the reference (ground) voltage node.

The current source Iaz is disposed between the drain of the transistor Q21 and the power supply voltage node. The current source Iaz supplies a reference current to the correction signal generation circuit 81.

The transistors Q23 and Q24 are cascode-connected between the current source Ivary and the reference (ground) voltage node. The gate of the transistor Q23 is connected to the node n15. The drain of the transistor Q23 is connected to the current source Ivary, the gate and the drain of the transistor Q25, and the gate of the transistor Q26. The source of the transistor Q23 is connected to the gate and the drain of the transistor Q24. The source of the transistor Q24 is connected to the reference voltage node.

The current source Ivary is disposed between the drain of the transistor Q23 and the power supply voltage node. The current source Ivary is a variable current source. As described above, the other end (gate of the transistor Q23) side of the capacitor C11 changes depending on the potential of the dummy event signal VevA output from the dummy EVS pixel circuit 72. Thus, the drain potential of the transistor Q23 also changes depending on the potential of the dummy event signal VevA output from the dummy EVS pixel circuit 72. Specifically, when the potential of the dummy event signal VevA decreases, a current hardly flows through the drain of the transistor Q23, and the drain potential of the transistor Q23 increases.

The transistors Q25 and Q26 constitute a current mirror circuit. The sources of the transistors Q25 and Q26 are both connected to the power supply voltage node. The source of the transistor Q26 is connected to the bias correction circuit 82. A current proportional to the current flowing through the current source Ivary flows through the transistors Q25 and Q26. The correction signal Vct is output from the drain of the transistor Q26. The drain of the transistor Q26 is connected to the output node of the corrector 85 in the bias correction circuit 82, and is connected to the EVS pixel circuit 52 and the dummy EVS pixel circuit 72.

The bias generation unit 84 in the bias correction circuit 82 includes a current source Ibias. The current source Ibias supplies the bias signal Vbdiff to the corrector 85.

The correction signal Vct is input to the corrector 85 via a node n16. The corrector 85 includes a transistor Q27. The transistor Q27 corrects the bias signal Vbdiff using the correction signal Vct. As the transistor Q27, for example, an NMOS transistor is used. The bias signal Vbdiff is supplied from the bias generation unit 84 to the drain of the transistor Q27 to which the node n16 is connected. The gate of the transistor Q27 is connected to the node n16. The source of the transistor Q27 is connected to the reference voltage (ground) node.

The corrector 85 outputs the bias correction signal VbdiffA via the node n16. In FIG. 10, the bias correction signal VbdiffA has an opposite phase to the noise component of the dummy differential signal VpA.

In the comparator 56 in the EVS pixel circuit 52, the differential signal Vp corresponding to the change amount of the light amount of the incident light is input to the gate of the transistor Q15, and the bias correction signal VbdiffA is input to the gate of the transistor Q16. As a result, the comparator 56 compares the differential signal Vp with the bias correction signal VbdiffA. The event signal Vev in which noise caused by crosstalk is canceled is output from the output node n5, which is a connection node of the transistors Q15 and Q16.

Note that the bias correction signal VbdiffA and the correction signal Vct may be current signals, or may be voltage signals.

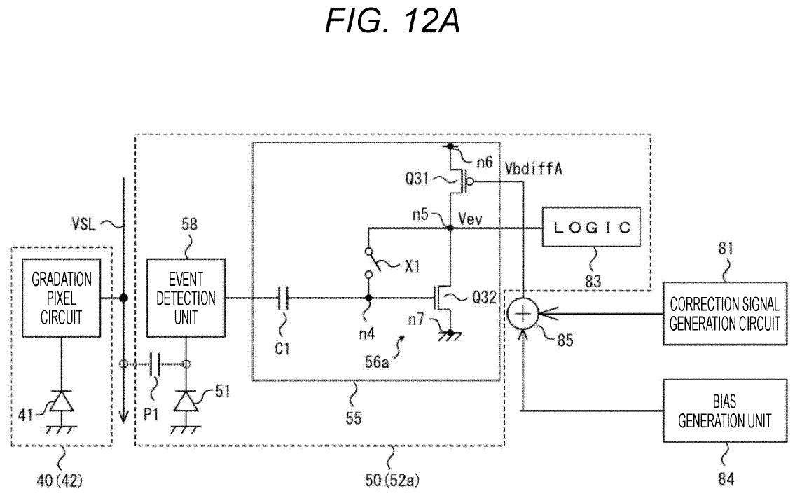

FIG. 11 is a timing chart of the crosstalk correction according to the first embodiment of the present disclosure. An initialization operation is performed from time t1 to time t2. At the time t1, the switch X1 is turned on. As a result, in the comparator 56 in the EVS pixel circuit 52 and the dummy EVS pixel circuit 72, the gate and the drain of the transistor Q15 are short-circuited, and the differentiation circuit 55 is initialized.

Furthermore, at the time t1, the switch X11 is also turned on simultaneously with the switch X1. As a result, the bias signal Vbdiff before being corrected by the corrector 85 is input to both the comparator 56 in the EVS pixel circuit 52 and the comparator 56 in the dummy EVS pixel circuit 72.

At the time t2, the switch X1 and the switch X11 are turned off, and the switch X12 is turned on. As a result, the event signal Vev may be supplied from the dummy EVS pixel circuit 72 to the correction signal generation circuit 81, and crosstalk may be corrected.

When high-intensity light is incident on the gradation pixel 40 at time t3, the potential of the pixel signal Vimg output from the gradation pixel 40 to the signal line VSL rapidly decreases. As a result, crosstalk occurs in the dummy EVS pixel 70, and the dummy event signal VevA erroneously detected by the dummy EVS pixel circuit 72 is supplied to the correction signal generation circuit 81. The bias correction circuit 82 generates a bias correction signal VbdiffA for offsetting a component of the crosstalk included in the differential signal Vp in the EVS pixel circuit 52, and supplies it to the EVS pixel circuit 52.

This similarly applies to a case where the light amount of the light incident on the gradation pixel 40 rapidly decreases at time t4. In this case, the potential of the pixel signal Vimg output from the gradation pixel 40 to the signal line VSL rapidly increases. Also in this case, crosstalk occurs in the dummy EVS pixel 70, and the dummy event signal VevA erroneously detected by the dummy EVS pixel circuit 72 is supplied to the correction signal generation circuit 81. The bias correction circuit 82 generates a bias correction signal VbdiffA for offsetting a component of the crosstalk included in the differential signal Vp in the EVS pixel circuit 52, and supplies it to the EVS pixel circuit 52.

The internal configuration of the comparator 56 described above is not limited to that illustrated in FIG. 10, and various variations may be taken. While the differential signal Vp is input to the PMOS transistor and the bias correction signal VbdiffA is input to the NOMS transistor in the comparator 56 illustrated in FIG. 10, this may be reversed.

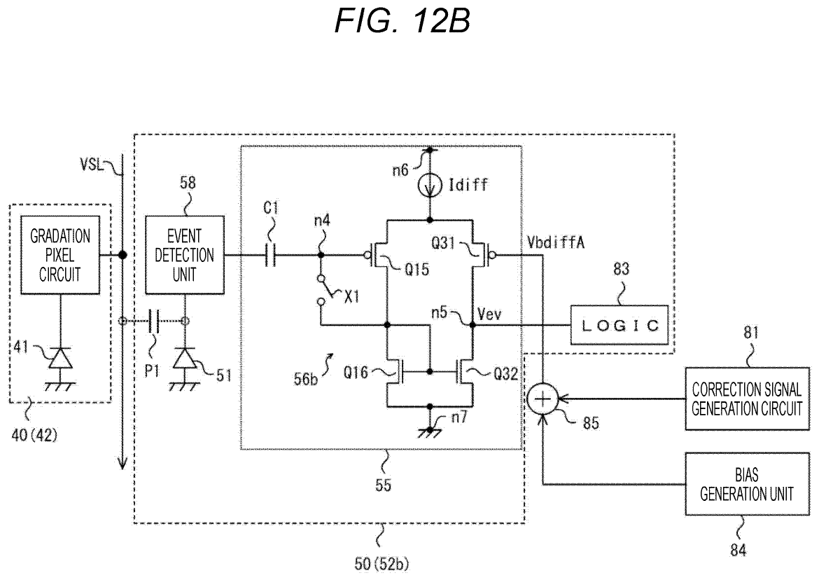

FIG. 12A is a diagram illustrating a first variation of the comparator 56. An EVS pixel circuit 52a illustrated in FIG. 12A includes a comparator 56a. The comparator 56a includes a transistor (third transistor) Q31 and a transistor (fourth transistor) Q32 instead of the transistors Q15 and Q16 in FIG. 10. A PMOS transistor is used as the transistor Q31, and an NMOS transistor is used as the transistor Q32. In a similar manner to the transistors Q15 and Q16, the transistors Q31 and Q32 are cascode-connected between the power supply voltage node n6 and the reference (ground) voltage node n7.

The bias correction signal VbdiffA is input to the gate of the transistor Q31, and the source and the drain of the transistor Q31 are connected to the power supply voltage node n6 and the output node n5, respectively. The differential signal Vp is input to the gate of the transistor Q32 via the input node N4, and the source and the drain of the transistor Q32 are connected to the reference (ground) voltage node n7 and the output node n5, respectively.

The comparator 56 may have a differential comparator structure. FIG. 12B is a diagram illustrating a second variation of the comparator 56. An EVS pixel circuit 52b illustrated in FIG. 12B includes a comparator 56b. The comparator 56b includes the transistors Q15, Q16, Q31, and Q32, and a current source Idiff. The transistors Q15 and Q16 are cascode-connected between the power supply voltage node n6 and the reference (ground) voltage node n7 in a similar manner to FIG. 10. The transistors Q31 and Q32 are cascode-connected between the power supply voltage node n6 and the reference (ground) voltage node n7 in a similar manner to FIG. 12A. The current source Idiff is disposed between the sources of the transistors Q15 and Q31 and the power supply voltage node n6.

The bias correction signal VbdiffA is input to the gate of the transistor Q31. The differential signal Vp is input to the gate of the transistor Q15, the drain and gate of the transistor Q16, and the gate of the transistor Q32. The event signal Vev is output from the output node n5, which is a connection node of the transistors Q31 and Q32.

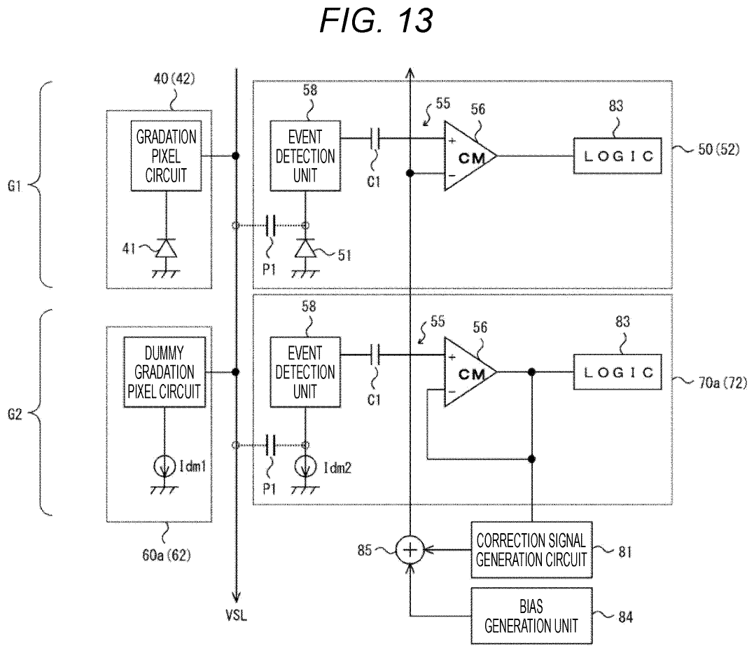

The dummy gradation pixel 60 and the dummy EVS pixel 70 do not necessarily include the photoelectric conversion element 71. FIG. 13 is a diagram illustrating a variation of the dummy gradation pixel 60 and the dummy EVS pixel 70. A dummy gradation pixel 60a illustrated in FIG. 13 includes a current source (first current source) Idm1 instead of the photoelectric conversion element 71. The current source Idm1 supplies, to the dummy gradation pixel circuit 62, a current equivalent to the current flowing through the photoelectric conversion element 41 in the gradation pixel 40. The dummy gradation pixel circuit 62 outputs a dummy pixel signal on the basis of the current flowing through the current source Idm1. A dummy EVS pixel 70a includes a current source (second current source) Idm2 instead of the photoelectric conversion element 71. The current source Idm2 supplies a current equivalent to the current flowing through the photoelectric conversion element 51 in the EVS pixel 50 to the event detection unit 58 in the dummy EVS pixel circuit 72. The dummy EVS pixel circuit 72 detects a dummy event on the basis of the current flowing through the current source Idm2.

As described above, in the first embodiment, the dummy gradation pixel 60 and the dummy EVS pixel 70 are provided for each signal line VSL. The dummy gradation pixel 60 and the dummy EVS pixel 70 are arranged in the optical black region OPB, for example, and are light-shielded. When the potential of the pixel signal on the signal line VSL rapidly changes, crosstalk occurs in the dummy EVS pixel 70 in a similar manner to the EVS pixel 50. Thus, the bias correction signal VbdiffA is generated by the correction signal generation circuit 81 and the bias correction circuit 82 on the basis of the dummy event signal VevA output from the dummy EVS pixel circuit 72. By the bias correction signal VbdiffA being supplied to the comparator 56 in the EVS pixel circuit 52, crosstalk may be offset.

That is, according to the first embodiment, in a case where the gradation pixel 40 and the EVS pixel 50 are mixedly mounted, even if the potential of the pixel signal Vimg output from the gradation pixel 40 rapidly changes and crosstalk occurs in the EVS pixel 50, the bias correction signal VbdiffA that offsets the generated crosstalk is generated, whereby an event may be detected without being affected by the crosstalk.

### Second Embodiment

In the first embodiment, crosstalk that occurs between a signal line VSL extending in a second direction Y and an EVS pixel 50 is offset. The crosstalk may occur between a signal line extending in a first direction X and the EVS pixel 50.

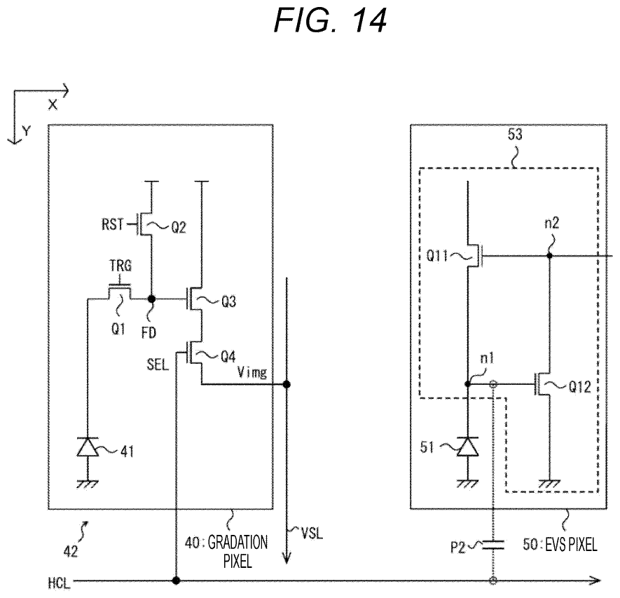

FIG. 14 is a circuit diagram illustrating a second example of the crosstalk that occurs between a gradation pixel 40 and the EVS pixel 50. A selection control signal SEL is input to a transistor Q4 in the gradation pixel 40 from a selection control line HCL extending in the first direction X. As illustrated in FIG. 3, multiple EVS pixels 50 in a pixel array unit 30 are alternately arranged with the gradation pixels 40 in the first direction X, and are arranged close to each other in the second direction Y.

A parasitic capacitance P2 may be formed between the selection control line HCL and a node n1 connected to a cathode of a photoelectric conversion element 51 in the EVS pixel 50. When signal logic of the selection control signal SEL transitions to the gradation pixel 40 via the selection control line HCL, the potential of the node n1 in the EVS pixel 50 may change via the parasitic capacitance P2. As a result, an EVS pixel circuit 52 may erroneously recognize the potential change of the node n1 as occurrence of an event, and may change the logic of an event detection signal.

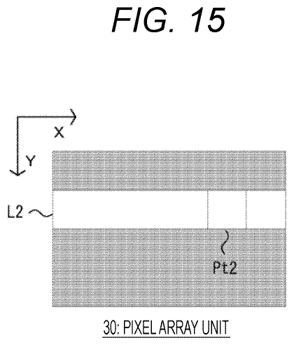

Since the selection control signal SEL extends in the first direction X, erroneous detection of an event caused by the crosstalk may simultaneously occur in a plurality of the EVS pixel circuits 52 arranged in the first direction X. FIG. 15 is a diagram schematically illustrating the EVS pixel circuit 52 in which the crosstalk occurs in a case where the signal logic of the selection control signal SEL transitions in the gradation pixel 40 of a pixel group Pt2 at a specific pixel position. FIG. 15 illustrates an exemplary case where the EVS pixel circuits 52 of all the pixel groups in the same pixel row as the pixel group Pt2 erroneously detect an event. Accordingly, a streaky line L2 appears in the event detection image in the first direction X.

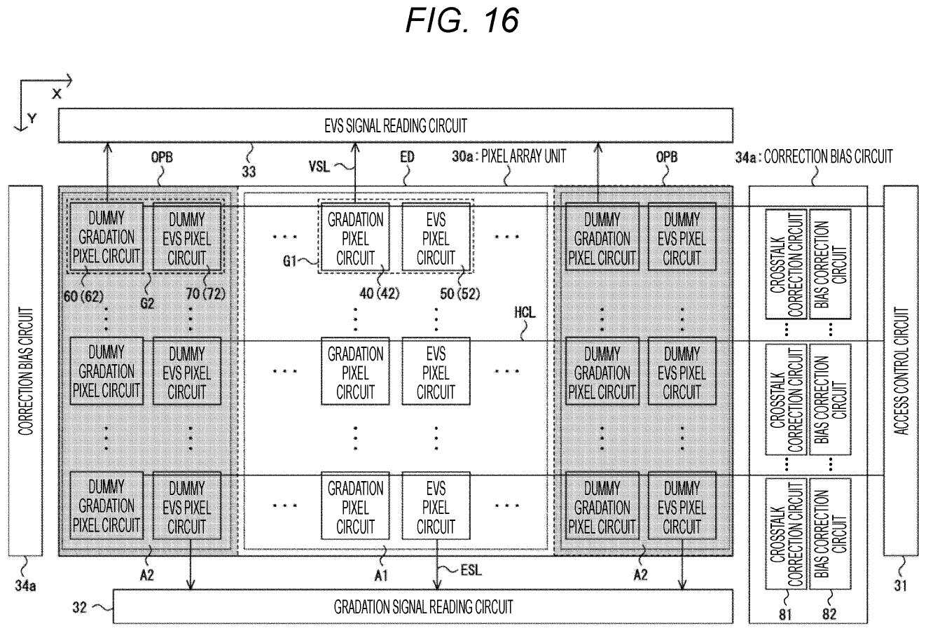

FIG. 16 is a block diagram illustrating a detailed configuration of the pixel array unit 30 and a correction circuit 34 according to the second embodiment of the present disclosure. In a pixel array unit 30a illustrated in FIG. 16, an optical black region OPB is arranged at an end in the first direction X. A second pixel region A2 in FIG. 16 is arranged at an end in the first direction X in the optical black region OPB. Note that, in FIG. 16, illustration of photoelectric conversion elements 41, 51, 61, and 71 is omitted.

A plurality of the selection control lines HCL extends in the first direction X while being spaced apart from each other in the second direction Y. A plurality of gradation pixel circuits 42 is connected to the plurality of respective selection control lines HCL.

A correction circuit 34a illustrated in FIG. 16 includes a plurality of correction signal generation circuits 81 and a plurality of bias correction circuits 82 in association with the plurality of selection control lines HCL. The correction signal generation circuit 81 in FIG. 10 generates a correction signal Vct according to a potential change of the corresponding signal line VSL. Likewise, each of the plurality of correction signal generation circuits 81 in FIG. 16 generates the correction signal Vct according to a potential change of the corresponding selection control line HCL.

While the correction circuit 34a and the second pixel region A2 are arranged at both ends of the pixel array unit 30a in the first direction X in FIG. 16, they may be arranged at any one end of the pixel array unit 30a in the first direction X.

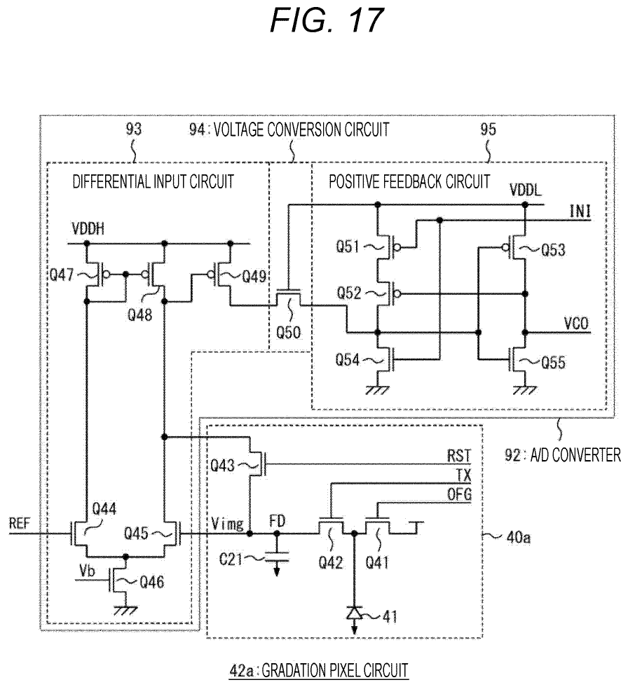

The gradation pixel circuit 42 in the second embodiment may include an analog-to-digital (AD) converter that performs analog-digital conversion on a pixel signal Vimg. FIG. 17 is a circuit diagram illustrating a variation of the gradation pixel circuit 42. A gradation pixel circuit 42a illustrated in FIG. 17 includes a gradation pixel 40a and an A/D converter 92. The A/D converter 92 performs analog-digital conversion on the pixel signal Vimg corresponding to a light amount of incident light. The A/D converter 92 includes a differential input circuit 93, a voltage conversion circuit 94, and a positive feedback circuit 95. The configuration of the gradation pixel circuit 42a illustrated in FIG. 17 is referred to as a pixel ADC configuration.

The gradation pixel 40a includes the photoelectric conversion element 41, a discharge transistor Q41, a transfer transistor Q42, a floating diffusion FD, a capacitor C21, and a reset transistor Q43. As the reset transistor Q43, the transfer transistor Q42, and the discharge transistor Q41, for example, NMOS transistors are used.

The photoelectric conversion element 41 generates charges by photoelectric conversion. The discharge transistor Q41 discharges the charges accumulated in the photoelectric conversion element 41 at a start of exposure in accordance with a drive signal OFG. The drive signal OFG is supplied to the gate of the discharge transistor Q41.

The transfer transistor Q42 transfers the charges from the photoelectric conversion element 41 to the floating diffusion FD at an end of exposure in accordance with a transfer signal TX. The transfer signal TX is supplied to the gate of the transfer transistor Q42. The transfer transistor Q42 has the drain connected to the discharge transistor Q41, and the source connected to the floating diffusion FD.

The floating diffusion FD accumulates the transferred charges, and generates a potential corresponding to an amount of accumulated charges. In FIG. 17, the capacitance of the floating diffusion FD is equivalently represented by the capacitor C21.

In accordance with a reset signal RST, the reset transistor Q43 shifts to the on state and initializes the potential of the floating diffusion FD. The reset signal RST is supplied to the gate of the reset transistor Q43. The reset transistor Q43 has the source connected to the floating diffusion FD and to the differential input circuit 93, and the drain connected to the differential input circuit 93.

The differential input circuit 93 includes NMOS transistors Q44, Q45, and Q46, and PMOS transistors Q47, Q48, and Q49.

The NMOS transistors Q44 and Q45 form a differential pair, and the sources of those transistors are commonly connected to the drain of the NMOS transistor Q46. Furthermore, the drain of the NMOS transistor Q44 is connected to the drain of the PMOS transistor Q47 and the gates of the PMOS transistors Q47 and Q48. The drain of the NMOS transistor Q45 is connected to the drain of the PMOS transistor Q48, the gate of the PMOS transistor Q49, and the drain of the reset transistor Q43. Furthermore, a reference signal REF from a digital-to-analog converter (DAC) (not illustrated) is input to the gate of the NMOS transistor Q44. The pixel signal Vimg is input from the gradation pixel 40a to the gate of the NMOS transistor Q45.

A bias voltage Vb is applied to the gate of the NMOS transistor Q46, and the source of the NMOS transistor Q46 is connected to a reference voltage node.

The PMOS transistors Q47, Q48, and Q49 constitute a current mirror circuit. A power supply voltage VDDH is applied to the sources of the PMOS transistors Q47, Q48, and Q49. The power supply voltage VDDH is at a voltage level higher than that of a power supply voltage VDDL supplied to the voltage conversion circuit 94 and to the positive feedback circuit 95. Furthermore, the drain of the PMOS transistor Q49 is connected to the voltage conversion circuit 94.

The voltage conversion circuit 94 includes an NMOS transistor Q50. The power supply voltage VDDL is applied to the gate of the NMOS transistor Q50. The NMOS transistor Q50 has the source connected to the drain of the PMOS transistor Q49, and the drain connected to the positive feedback circuit 95.

The positive feedback circuit 95 includes PMOS transistors Q51, Q52, and Q53, and NMOS transistors Q54 and Q55.

The PMOS transistors Q51 and Q52 and the NMOS transistor Q54 are cascode-connected between a power supply voltage VDDL node and a ground voltage node. Furthermore, a drive signal INI is input to the gates of the PMOS transistor Q51 and NMOS transistor Q54. Furthermore, a connection node of the PMOS transistor Q52 and NMOS transistor Q54 is connected to the voltage conversion circuit 94.

The PMOS transistor Q53 and the NMOS transistor Q55 are cascode-connected between the power supply voltage VDDL node and the ground voltage node. The gates of those transistors are connected to the connection node of the PMOS transistor Q52 and NMOS transistor Q54. A signal VCO indicating a result of comparison between a reference signal and the pixel signal Vimg corresponding to the light amount of the incident light is output from the connection node of the PMOS transistor Q53 and NMOS transistor Q55. By holding a time code generated by a time code generation unit (not illustrated) at the timing when the potential level of the signal VCO changes, a digital pixel signal, which is obtained by the pixel signal Vimg being subject to analog-digital conversion, is generated.

The gradation pixel circuit 42a in FIG. 17 may be adopted as a configuration of the gradation pixel circuit 42 and the dummy gradation pixel circuit 62 in the pixel array unit 30a illustrated in FIG. 16. In this case, each of a plurality of the signal lines VSL transmits a digital pixel signal. The selection control line HCL transmits the drive signal INI to the gradation pixel circuit 42a. The selection control line HCL may input the bias voltage Vb to the gradation pixel circuit 42a.

As described above, in the second embodiment, a dummy gradation pixel 60, a dummy EVS pixel 70, the correction signal generation circuit 81, and the bias correction circuit 82 are arranged for each selection control line HCL, whereby the crosstalk that occurs between the selection control line HCL and the signal path connected to the cathode of the photoelectric conversion element 51 in the EVS pixel 50 may be offset. Furthermore, the gradation pixel circuit 42 according to the second embodiment may have the pixel ADC configuration. Even with the configuration in which the EVS pixel circuit 52 and the gradation pixel circuit 42a having the pixel ADC configuration are combined, the crosstalk generated in the EVS pixel 50 may be offset.

### Application Example

The technology according to the present disclosure may be applied to various products. For example, the technology according to the present disclosure may also be implemented as a device included in any type of mobile body such as an automobile, an electric automobile, a hybrid electric automobile, a motorcycle, a bicycle, a personal mobility, an airplane, a drone, a ship, a robot, a construction machine, an agricultural machine (tractor), or the like.

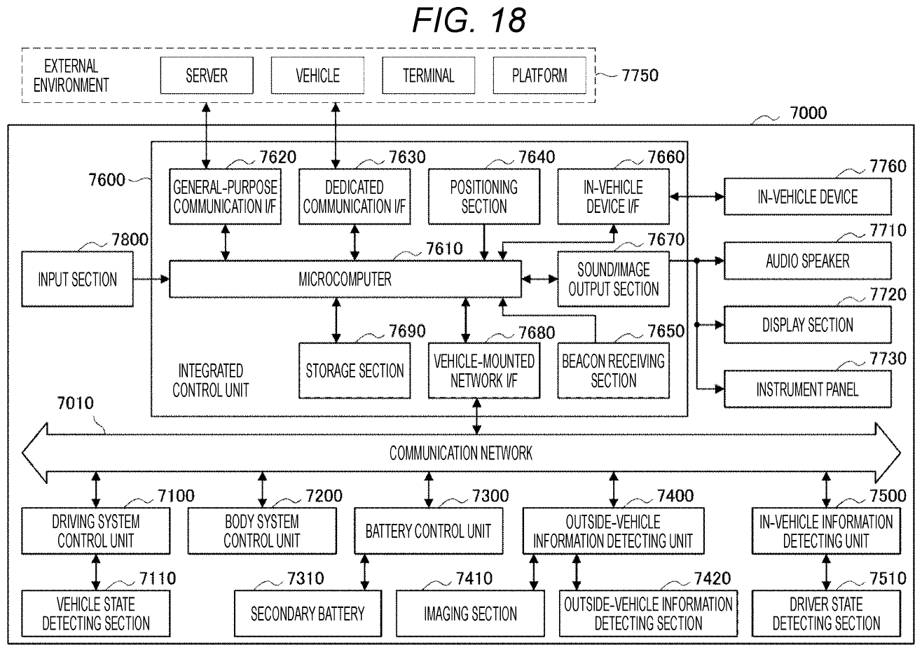

FIG. 18 is a block diagram illustrating an exemplary schematic configuration of a vehicle control system 7000, which is an example of a mobile body control system to which the technology according to the present disclosure may be applied. The vehicle control system 7000 includes a plurality of electronic control units connected to each other via a communication network 7010. In the example illustrated in FIG. 18, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. In FIG. 18, a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690 are illustrated as functional components of the integrated control unit 7600. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

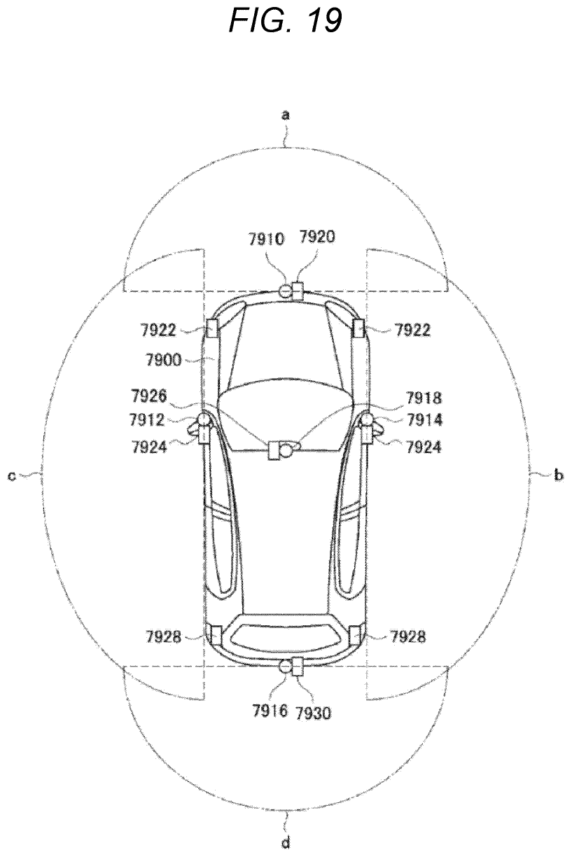

Here, FIG. 19 illustrates exemplary installation positions of the imaging section 7410 and outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Note that FIG. 19 illustrates an exemplary imaging range of each of the imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Referring back to FIG. 18, the description continues. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAN) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automated driving, which makes the vehicle to travel automatedly without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example in FIG. 18, an audio speaker 7710, a display section 7720, and an instrument panel 7730 are exemplified as output devices. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Note that, in the example illustrated in FIG. 18, at least two control units connected to each other via the communication network 7010 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

Note that the present technology may have the following configurations.

(1) A photodetection element, which includes a plurality of pixel groups in which each of the plurality of pixel groups includes:
a first pixel and a first pixel circuit that output a pixel signal corresponding to a light amount of incident light;
a second pixel that detects a change amount of the light amount of the incident light; and
a second pixel circuit that compares the change amount detected by the second pixel with a bias signal to detect an event,
the photodetection element including:
a correction signal generation circuit that generates a correction signal for offsetting crosstalk in which the pixel signal affects the detection of the event; and
a bias correction circuit that generates a bias correction signal obtained by correcting the bias signal on the basis of the correction signal, in which
the second pixel circuit compares the change amount of the light amount of the incident light with the bias correction signal to detect the event.

(2) The photodetection element according to (1), further including:
a dummy pixel group having the same structure as at least a part of the pixel group and light-shielded, in which
the correction signal generation circuit generates the correction signal on the basis of an output signal of the dummy pixel group.

(3) The photodetection element according to (2), in which
the dummy pixel group has the same circuit configuration, shape, and size as at least a part of the pixel group.

(4) The photodetection element according to (2) or (3), in which
the dummy pixel group includes:
a first dummy pixel and a first dummy pixel circuit having the same structure as at least a part of the first pixel and the first pixel circuit; and
a second dummy pixel and a second dummy pixel circuit having the same structure as at least a part of the second pixel and the second pixel circuit, and
the correction signal generation circuit generates the correction signal on the basis of an output signal of the second dummy pixel circuit.

(5) The photodetection element according to (4), in which
the first pixel includes a first photoelectric conversion element that accumulates a charge corresponding to the light amount of the incident light,
the second pixel includes a second photoelectric conversion element that accumulates the charge corresponding to the light amount of the incident light,
the first dummy pixel includes a third photoelectric conversion element that has the same structure as the first photoelectric conversion element and accumulates the charge in a light-shielded state,
the second dummy pixel includes a fourth photoelectric conversion element that has the same structure as the second photoelectric conversion element and accumulates the charge in the light-shielded state,
the first pixel circuit outputs the pixel signal on the basis of the charge accumulated in the first photoelectric conversion element,
the second pixel circuit detects the event on the basis of the charge accumulated in the second photoelectric conversion element,
the first dummy pixel circuit outputs a dummy pixel signal on the basis of the charge accumulated in the third photoelectric conversion element, and
the second dummy pixel circuit detects a dummy event on the basis of the charge accumulated in the fourth photoelectric conversion element.

(6) The photodetection element according to (4), in which
the first pixel includes a first photoelectric conversion element that accumulates a charge corresponding to the light amount of the incident light,
the second pixel includes a second photoelectric conversion element that accumulates the charge corresponding to the light amount of the incident light,
the first dummy pixel includes a first current source that carries a current equivalent to a current corresponding to the charge accumulated in the first photoelectric conversion element,
the second dummy pixel includes a second current source that carries a current equivalent to the current corresponding to the charge accumulated in the first photoelectric conversion element,
the first pixel circuit outputs the pixel signal on the basis of the charge accumulated in the first photoelectric conversion element,
the second pixel circuit detects the event on the basis of the charge accumulated in the second photoelectric conversion element,
the first dummy pixel circuit outputs a dummy pixel signal on the basis of the current flowing through the first current source, and
the second dummy pixel circuit detects a dummy event on the basis of the current flowing through the second current source.

(7) The photodetection element according to any one of (2) to (6), in which
the plurality of pixel groups includes:
two or more of the pixel groups arranged along a first direction; and
two or more of the dummy pixel groups arranged along the first direction,
the correction signal generation circuit is provided for each of the two or more dummy pixel groups, and
the correction signal generation circuit generates the correction signal on the basis of the output signal of the dummy pixel group corresponding to the correction signal generation circuit.

(8) The photodetection element according to (7), in which
the plurality of pixel groups includes two or more of the pixel groups arranged along a second direction that intersects the first direction, and
the output signal of each of the two or more dummy pixel groups arranged along the first direction is supplied to the correction signal generation circuit of the corresponding pixel group arranged along the second direction.

(9) The photodetection element according to any one of (2) to (6), further including:
a first pixel region including the plurality of pixel groups arranged along a first direction and a second direction that intersect each other; and
a second pixel region that is arranged at an end of the first pixel region in the first direction or in the second direction and includes the dummy pixel group.

(10) The photodetection element according to (9), further including:
a plurality of signal lines that is arranged in the first direction in a manner of being spaced apart from each other and extends in the second direction, in which
each of the plurality of signal lines transmits the pixel signal output from a plurality of the first pixels arranged along the second direction,
a plurality of the correction signal generation circuits and a plurality of the bias correction circuits are provided in association with the plurality of signal lines, and
each of the plurality of the correction signal generation circuits generates the correction signal according to a potential change of the corresponding signal line.

(11) The photodetection element according to (10), in which
the second pixel region is arranged at an end of the first pixel region in the second direction.

(12) The photodetection element according to (9), further including:
a plurality of selection control lines that is arranged in the second direction in a manner of being spaced apart from each other and extends in the first direction, in which
each of the plurality of selection control lines transmits a selection control signal that selects a plurality of the first pixels arranged along the first direction,
a plurality of the correction signal generation circuits and a plurality of the bias correction circuits are provided in association with the plurality of selection control lines, and
each of the plurality of correction signal generation circuits generates the correction signal according to a potential change of the corresponding selection control line.

(13) The photodetection element according to (12), in which
the second pixel region is arranged at an end of the second pixel region in the first direction.

(14) The photodetection element according to (12) or (13), further including:
a plurality of signal lines that is arranged in the first direction in a manner of being spaced apart from each other and extends in the second direction; and
a plurality of the first pixels and the first pixel circuits respectively connected to the plurality of signal lines, in which
each of the plurality of first pixel circuits includes an A/D converter that performs analog-digital conversion on the pixel signal corresponding to the light amount of the incident light, and
each of the plurality of signal lines transmits the pixel signal that has been subject to the analog-digital conversion in the plurality of first pixels arranged along the second direction.

(15) The photodetection element according to any one of (9) to (14), further including:
a pixel array unit including the first pixel region and the second pixel region, in which
the second pixel region is arranged in an optical black region arranged at at least one end of the pixel array unit in the first direction or in the second direction.

(16) The photodetection element according to any one of (1) to (15), in which
the second pixel circuit includes a comparator that compares the bias correction signal with a signal corresponding to the change amount of the light amount of the incident light.

(17) The photodetection element according to (16), in which
the comparator includes a first transistor of a first conductivity type and a second transistor of a second conductivity type cascode-connected between a first reference voltage node and a second reference voltage node,
a voltage signal corresponding to the change amount of the light amount of the incident light is input to a gate of the first transistor,
the bias correction signal is input to a gate of the second transistor, and
a detection signal of the event is output from a connection node of the first transistor and the second transistor.

(18) The photodetection element according to (16), in which the comparator includes:
a first transistor of a first conductivity type and a second transistor of a second conductivity type cascode-connected between a first reference voltage node and a second reference voltage node; and
a third transistor of the first conductivity type and a fourth transistor of the second conductivity type cascode-connected between the first reference voltage node and the second reference voltage node, in which
the bias correction signal is input to a gate of the third transistor,
a voltage signal corresponding to the change amount of the light amount of the incident light is input to a gate of the first transistor, a drain and a gate of the second transistor, and a gate of the fourth transistor, and
a detection signal of the event is output from a connection node of the third transistor and the fourth transistor.

(19) An electronic device including:
a photodetection element; and
a processing unit that processes image data output from the photodetection element, in which
the photodetection element includes a photodetection element in which:
a plurality of pixel groups is included; and
each of the plurality of pixel groups includes:
a first pixel and a first pixel circuit that output a pixel signal corresponding to a light amount of incident light;
a second pixel that detects a change amount of the light amount of the incident light; and
a second pixel circuit that compares the change amount detected by the second pixel with a bias signal to detect an event,
the photodetection element including:
a correction signal generation circuit that generates a correction signal for offsetting crosstalk in which the pixel signal affects the detection of the event; and
a bias correction circuit that generates a bias correction signal obtained by correcting the bias signal on the basis of the correction signal, in which
the second pixel circuit compares the change amount of the light amount of the incident light with the bias correction signal to detect the event.

Modes of the present disclosure are not limited to the individual embodiments described above, but include various modifications that may be conceived by those skilled in the art, and the effects of the present disclosure are not limited to the contents described above. That is, various additions, modifications, and partial deletions may be made without departing from the conceptual idea and spirit of the present disclosure derived from the matters defined in the claims and equivalents thereof.

### REFERENCE SIGNS LIST

1 Electronic device
2 Photodetection element
3 Processing unit
4 Control unit
Recording unit
11 Imaging lens
12 Transmission line
13 Control line
21 Pixel chip
22 Circuit chip
30, 30a Pixel array unit
31 Access control circuit
32 Gradation signal reading circuit
33 EVS signal reading circuit
34, 34a Correction circuit
40, 40a Gradation pixel
41, 51, 61, 71 Photoelectric conversion element
42 Gradation pixel circuit
43 Buffer
44 Differentiation circuit
50 EVS pixel
52, 52a, 52b EVS pixel circuit
53 Current-voltage conversion circuit
54 Buffer
55 Differentiation circuit
56, 56a, 56b Comparator
57 Logarithmic response unit
58 Event detection unit
60, 60a Dummy gradation pixel
62 Dummy gradation pixel circuit
70, 70a Dummy EVS pixel
72 Dummy EVS pixel circuit
73 Connection unit
81 Correction signal generation circuit
82 Bias correction circuit
83 Logic circuit
84 Bias generation unit
85 Corrector
92 A/D converter
93 Differential input circuit
94 Voltage conversion circuit
95 Positive feedback circuit

1. A photodetection element including a plurality of pixel groups,
each of the plurality of pixel groups including:
a first pixel and a first pixel circuit that output a pixel signal corresponding to a light amount of incident light;
a second pixel that detects a change amount of the light amount of the incident light; and
a second pixel circuit that compares the change amount detected by the second pixel with a bias signal to detect an event,
the photodetection element comprising:
a correction signal generation circuit that generates a correction signal for offsetting crosstalk in which the pixel signal affects the detection of the event; and
a bias correction circuit that generates a bias correction signal obtained by correcting the bias signal on a basis of the correction signal, wherein
the second pixel circuit compares the change amount of the light amount of the incident light with the bias correction signal to detect the event.

2. The photodetection element according to claim 1, further comprising:
a dummy pixel group having a same structure as at least a part of the pixel group and light-shielded, wherein
the correction signal generation circuit generates the correction signal on a basis of an output signal of the dummy pixel group.

3. The photodetection element according to claim 2, wherein
the dummy pixel group has a same circuit configuration, shape, and size as at least a part of the pixel group.

4. The photodetection element according to claim 2, wherein
the dummy pixel group includes:
a first dummy pixel and a first dummy pixel circuit having a same structure as at least a part of the first pixel and the first pixel circuit; and
a second dummy pixel and a second dummy pixel circuit having a same structure as at least a part of the second pixel and the second pixel circuit, and
the correction signal generation circuit generates the correction signal on a basis of an output signal of the second dummy pixel circuit.

5. The photodetection element according to claim 4, wherein
the first pixel includes a first photoelectric conversion element that accumulates a charge corresponding to the light amount of the incident light,
the second pixel includes a second photoelectric conversion element that accumulates the charge corresponding to the light amount of the incident light,
the first dummy pixel includes a third photoelectric conversion element that has a same structure as the first photoelectric conversion element and accumulates the charge in a light-shielded state,
the second dummy pixel includes a fourth photoelectric conversion element that has a same structure as the second photoelectric conversion element and accumulates the charge in the light-shielded state,
the first pixel circuit outputs the pixel signal on a basis of the charge accumulated in the first photoelectric conversion element,
the second pixel circuit detects the event on a basis of the charge accumulated in the second photoelectric conversion element,
the first dummy pixel circuit outputs a dummy pixel signal on a basis of the charge accumulated in the third photoelectric conversion element, and
the second dummy pixel circuit detects a dummy event on a basis of the charge accumulated in the fourth photoelectric conversion element.

6. The photodetection element according to claim 4, wherein
the first pixel includes a first photoelectric conversion element that accumulates a charge corresponding to the light amount of the incident light,
the second pixel includes a second photoelectric conversion element that accumulates the charge corresponding to the light amount of the incident light,
the first dummy pixel includes a first current source that carries a current equivalent to a current corresponding to the charge accumulated in the first photoelectric conversion element,
the second dummy pixel includes a second current source that carries a current equivalent to the current corresponding to the charge accumulated in the first photoelectric conversion element,
the first pixel circuit outputs the pixel signal on a basis of the charge accumulated in the first photoelectric conversion element,
the second pixel circuit detects the event on a basis of the charge accumulated in the second photoelectric conversion element,
the first dummy pixel circuit outputs a dummy pixel signal on a basis of the current flowing through the first current source, and
the second dummy pixel circuit detects a dummy event on a basis of the current flowing through the second current source.

7. The photodetection element according to claim 2, wherein
the plurality of pixel groups includes:
two or more of the pixel groups arranged along a first direction; and
two or more of the dummy pixel groups arranged along the first direction,
the correction signal generation circuit is provided for each of the two or more dummy pixel groups, and
the correction signal generation circuit generates the correction signal on a basis of the output signal of the dummy pixel group corresponding to the correction signal generation circuit.

8. The photodetection element according to claim 7, wherein
the plurality of pixel groups includes two or more of the pixel groups arranged along a second direction that intersects the first direction, and
the output signal of each of the two or more dummy pixel groups arranged along the first direction is supplied to the correction signal generation circuit of the corresponding pixel group arranged along the second direction.

9. The photodetection element according to claim 2, further comprising:
a first pixel region including the plurality of pixel groups arranged along a first direction and a second direction that intersect each other; and
a second pixel region that is arranged at an end of the first pixel region in the first direction or in the second direction and includes the dummy pixel group.

10. The photodetection element according to claim 9, further comprising:
a plurality of signal lines that is arranged in the first direction in a manner of being spaced apart from each other and extends in the second direction, wherein
each of the plurality of signal lines transmits the pixel signal output from a plurality of the first pixels arranged along the second direction,
a plurality of the correction signal generation circuits and a plurality of the bias correction circuits are provided in association with the plurality of signal lines, and
each of the plurality of the correction signal generation circuits generates the correction signal according to a potential change of the corresponding signal line.

11. The photodetection element according to claim 10, wherein
the second pixel region is arranged at an end of the first pixel region in the second direction.

12. The photodetection element according to claim 9, further comprising:
a plurality of selection control lines that is arranged in the second direction in a manner of being spaced apart from each other and extends in the first direction, wherein
each of the plurality of selection control lines transmits a selection control signal that selects a plurality of the first pixels arranged along the first direction,
a plurality of the correction signal generation circuits and a plurality of the bias correction circuits are provided in association with the plurality of selection control lines, and
each of the plurality of correction signal generation circuits generates the correction signal according to a potential change of the corresponding selection control line.

13. The photodetection element according to claim 12, wherein
the second pixel region is arranged at an end of the second pixel region in the first direction.

14. The photodetection element according to claim 12, further comprising:
a plurality of signal lines that is arranged in the first direction in a manner of being spaced apart from each other and extends in the second direction; and
a plurality of the first pixels and the first pixel circuits respectively connected to the plurality of signal lines, wherein
each of the plurality of first pixel circuits includes an A/D converter that performs analog-digital conversion on the pixel signal corresponding to the light amount of the incident light, and
each of the plurality of signal lines transmits the pixel signal that has been subject to the analog-digital conversion in the plurality of first pixels arranged along the second direction.

15. The photodetection element according to claim 9, further comprising:
a pixel array unit including the first pixel region and the second pixel region, wherein
the second pixel region is arranged in an optical black region arranged at at least one end of the pixel array unit in the first direction or in the second direction.

16. The photodetection element according to claim 1, wherein
the second pixel circuit includes a comparator that compares the bias correction signal with a signal corresponding to the change amount of the light amount of the incident light.

17. The photodetection element according to claim 16, wherein
the comparator includes a first transistor of a first conductivity type and a second transistor of a second conductivity type cascode-connected between a first reference voltage node and a second reference voltage node,
a voltage signal corresponding to the change amount of the light amount of the incident light is input to a gate of the first transistor,
the bias correction signal is input to a gate of the second transistor, and
a detection signal of the event is output from a connection node of the first transistor and the second transistor.

18. The photodetection element according to claim 16, wherein
the comparator includes:
a first transistor of a first conductivity type and a second transistor of a second conductivity type cascode-connected between a first reference voltage node and a second reference voltage node; and
a third transistor of the first conductivity type and a fourth transistor of the second conductivity type cascode-connected between the first reference voltage node and the second reference voltage node, wherein
the bias correction signal is input to a gate of the third transistor,
a voltage signal corresponding to the change amount of the light amount of the incident light is input to a gate of the first transistor, a drain and a gate of the second transistor, and a gate of the fourth transistor, and
a detection signal of the event is output from a connection node of the third transistor and the fourth transistor.

19. An electronic device comprising:
a photodetection element; and
a processing unit that processes image data output from the photodetection element, wherein
the photodetection element includes a photodetection element in which:
a plurality of pixel groups is included; and
each of the plurality of pixel groups includes:
a first pixel and a first pixel circuit that output a pixel signal corresponding to a light amount of incident light;
a second pixel that detects a change amount of the light amount of the incident light; and
a second pixel circuit that compares the change amount detected by the second pixel with a bias signal to detect an event,
the photodetection element including:
a correction signal generation circuit that generates a correction signal for offsetting crosstalk in which the pixel signal affects the detection of the event; and
a bias correction circuit that generates a bias correction signal obtained by correcting the bias signal on a basis of the correction signal, in which
the second pixel circuit compares the change amount of the light amount of the incident light with the bias correction signal to detect the event.
